(19) United States
(12) Patent Application Publication
(10) Pub. No.: US 2010/0138349 A1
(43) Pub. Date: Jun. 3, 2010

(54) Commission Payment Preclusion In Property Sale

(76) Inventor: Tam Choong Peng, Kota Damansara (MY)

Correspondence Address: Ashok Tankha, 36 Greenleigh Drive, Sewell, NJ, 08080, US

(21) Appl. No.: 12/326,085

(22) Filed: Dec. 1, 2008

(51) Int. Cl. G06Q 30/00; G06Q 40/00; G06Q 20/00; G06Q 50/00

(52) U.S. Cl. 705/80; 705/37

(57) ABSTRACT

Disclosed herein is a computer implemented method and system for negating payment of a commission to one or more real estate professionals by a property owner on sale of a property of the property owner over an electronic environment. The property owner sets a first list price for the property. The real estate professional sets a second list price. The property owner and the real estate professional enter into a sales agreement to list the property to a buyer at the set second list price over the electronic environment. The real estate professional negotiates a sale of the property at the second list price between the buyer and the property owner based on the sales agreement. The property is sold based on the negotiation. A return of the difference between the second list price and the first list price is remitted to the real estate professional.

### BACKGROUND

This invention, in general, relates to real estate purchasing and selling. More particularly, this invention relates to a method of negating payment of a commission to one or more real estate professionals by a property owner on sale of a property of the property owner over an electronic environment.

In a real estate transaction, a property owner typically contacts a licensed real estate broker for the sale or purchase of a property. The real estate broker assigns a real estate agent to represent the property owner for the sale or purchase transaction. In exchange for the real estate professional services the broker provides, the broker typically charges the seller of the property a commission which is typically a percentage of the selling price of the property. This commission is deducted from the property owner's net selling price. The real estate agent typically receives a part of the total commission received by the broker.

Property owners may be disadvantaged and discouraged from selling their property due to the commission paid to real estate professionals. Small commissions from a sale of a property may not provide the incentive necessary for a real estate agent to work diligently for the sale. A small commission may also not provide an incentive for the real estate agent to source buyers to obtain the best possible price for the property. Hence, there is a need for paying the real estate agent a commission more than the commission the real estate agent would make if he/she were paid by the seller of the property, for negating payment of the commission by the seller of the property when the property is sold, to encourage real estate agents to obtain the highest selling price for the seller of the property, and to promote sale of property through real estate brokers.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for negating payment of a commission to one or more real estate professionals by a property owner on sale of a property of the property owner over an electronic environment.

As used herein, a real estate professional is any real estate person who is involved in the sale or purchase of a property, including a real estate broker, a real estate sales agent, etc. Also, as used herein, the commission payable to a real estate professional on the sale of a property is referred to as a “return”. The computer implemented method disclosed herein is referred to as a “return scheme”. Also, as used herein, the price at which the property is sold to a buyer by the real estate professional is referred to as the “sale price”. Also, as used herein, the price at which a property is listed for sale is referred to as a “list price”.

In the method and system disclosed herein, the property owner sets a first list price for the property. The real estate professional handling the transaction agrees to the set first list price. Setting the first list price may comprise valuating the property to generate a valuation price in the electronic environment. The property owner may determine the first list price of the property based on the generated valuation price. The first list price may be lower than the generated valuation price. The real estate professional then sets a second list price greater than the agreed upon first list price. The real estate professional notifies the property owner regarding the second list price.

The property owner and the real estate professional then enter into a sales agreement. The sales agreement is an agreement to list the property of the property owner to a buyer at the second list price over the electronic environment. In the sales agreement, the property owner may simultaneously appoint a main agent and one or more secondary agents for selling the property. The appointed main agent and the appointed secondary agents may enter into an agreement with each other regarding the financial and other terms under which the appointed main agent and the appointed secondary agents may represent the property owner for the real state transaction including the distribution of fractions of the return between the main agent and the secondary agents on the sale of the property.

The real estate professional then negotiates the sale of the property between the buyer and the property owner at the second list price recited in the sales agreement. If the property is sold at the set second list price further an agreement reached between the buyer and the seller, a return equal to the difference between the second list price and the first list price is remitted to the real estate professional in the electronic environment. The remittance of the return negates payment of the commission to the real estate professional by the property owner. The return may be distributed among one or more real estate professionals. The property may be sold at a sale price above the second list price in which case the difference between the sale price and the second list price may be remitted to the real estate professional. The property owner may negotiate and sell the property at a sale price below the second list price in which case the difference between the second list price and the sale price is remitted by the property owner to the real estate professional.

The property owner or real estate professional may also negotiate and sell the property at a sale price below the first list price in which case the difference between the sale price below the first list price and the second list price is remitted by the property owner to the real estate professional. This holds true in the case of “urgent sale” or “force sale” of the property by the property owner. In an “urgent sale” scenario, the property owner sets a second list price of which the real estate professional agrees to. Should the property owner sell the property at a sale price below the first list price, then the difference between the sale price below the first list price and the second list price shall be borne by the property owner as “return” to the real estate professional.

The real estate professional may set multiple second list prices. Distribution of the return may be determined based on the second list prices. The distribution of the return between the main agent and secondary agent may be agreed upon between the main agent and secondary agent prior to the selling of the property. The real estate professional may offer a concession to the buyer in which case the concession is forfeited from the return to the real estate professional.

The return scheme gives the seller of the property freedom to choose a price for the property deemed appropriate by the property owner. The return scheme may also motivate the real estate to work more diligently for sourcing buyers. The return scheme also increases the net price that a seller realizes from the sale of his property.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of negating payment of a commission to one or more real estate professionals by a property owner on sale of property over an electronic environment.

FIG. 2 illustrates a computer implemented system for negating payment of a commission to a real estate professional by a property owner on sale of property over an electronic environment.

FIG. 3 exemplarily illustrates the property owner, the real estate professional, and a buyer connected to a real estate server via the internet.

FIG. 4 exemplarily illustrates the steps involved in selling the property of the property owner by the real estate professional.

FIG. 5 exemplarily illustrates the steps involved in selling the property of the property owner by a main agent with involvement of contributing parties.

FIG. 6 exemplarily illustrates the steps involved in selling the property of the property owner by a sole agent appointed by the property owner.

FIG. 7 exemplarily illustrates the steps involved in selling the property of the property owner with the involvement of a third party.

FIG. 8 exemplarily illustrates a schematic representation of appointment of the different real estate professionals.

FIG. 9 exemplarily illustrates a schematic representation of sale of the property of the property owner with the involvement of a third party.

FIG. 10 exemplarily illustrates the steps involved in selling the property of the property owner via the internet.

FIG. 11 exemplarily illustrates the steps involved in the registration of the property owner with the real estate website.

FIG. 12 exemplarily illustrates the steps involved in the property owner providing the property owner details on the real estate website.

FIG. 13 exemplarily illustrates the steps involved in providing property details on the real estate website.

FIG. 14 exemplarily illustrates the steps involved in regulating the sale of the property using the return scheme via the internet.

FIG. 15 exemplarily illustrates the steps involved in providing documents and certification by the property owner for the sale of the property.

FIG. 16 exemplarily illustrates the steps involved in the registration of the broker with the real estate website.

FIG. 17 exemplarily illustrates the steps involved in the broker providing broker details on the real estate website.

FIG. 18 exemplarily illustrates the steps involved in the broker providing information on type of property listing required by the broker on the real estate website.

FIG. 19 exemplarily illustrates the steps involved in regulating the return by the broker on the real estate website.

FIG. 20 exemplarily illustrates the steps involved in the broker providing the bank guarantee and required deposit on the real estate website.

FIG. 21 exemplarily illustrates the steps involved in the property owner accessing management options provided by the real estate website.

FIG. 22 exemplarily illustrates the steps involved in the property owner managing the property owner's user account on the real estate website.

FIG. 23 exemplarily illustrates the steps involved in the property owner managing the properties of the property owner on the real estate website.

FIG. 24 exemplarily illustrates the steps involved in the property owner managing the documents and certifications on the real estate website.

FIG. 25 exemplarily illustrates the steps involved in the property owner managing special sale arrangements on the real estate website.

FIG. 26 exemplarily illustrates the steps involved in the property owner managing the return scheme for regulating the sale on the real estate website.

FIG. 27 exemplarily illustrates the steps involved in the property owner managing the appointment of the agent or broker on the real estate website.

FIG. 28 exemplarily illustrates the steps involved in the property owner managing the main page options on the real estate website.

FIG. 29 exemplarily illustrates the steps involved in the broker accessing management options provided by the real estate website.

FIG. 30 exemplarily illustrates the steps involved in the broker managing the broker's user account on the real estate website.

FIG. 31 exemplarily illustrates the steps involved in the broker viewing a statement of accounts on the real estate website.

FIG. 32 exemplarily illustrates the steps involved in the broker managing a property list for sale on the real estate website.

FIG. 33 exemplarily illustrates the steps involved in the broker managing an auction of the property on the real estate website.

FIG. 34 exemplarily illustrates the steps involved in the broker managing the return scheme on the real estate website.

FIG. 35 exemplarily illustrates the steps involved when the broker manages the discounts on the properties given to the buyer on the real estate website.

FIG. 36 exemplarily illustrates the steps involved when the broker manages the main page options on the real estate website.

### DETAILED DESCRIPTION OF THE INVENTION

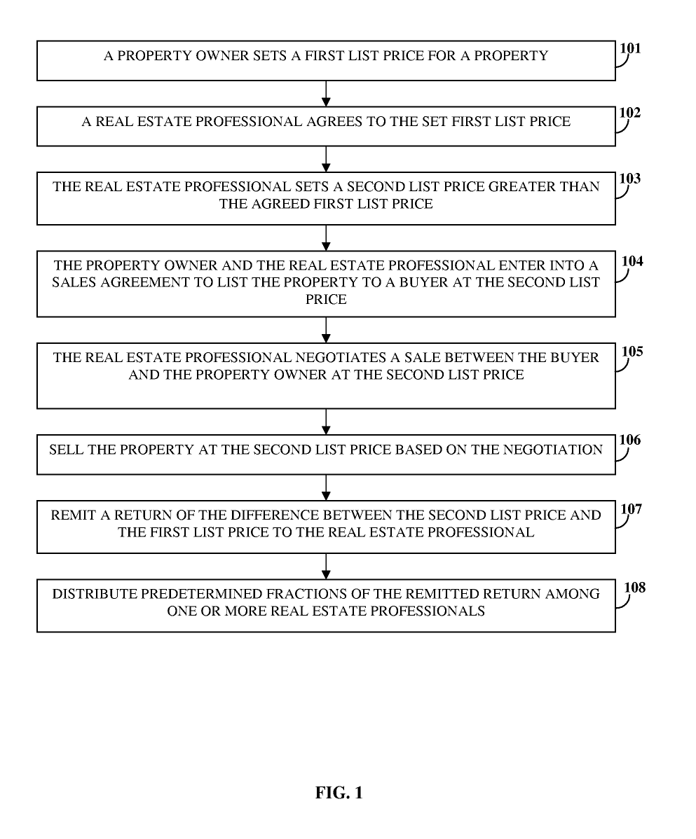

FIG. 1 illustrates a computer implemented method of negating payment of a commission to one or more real estate professionals by a property owner on sale of the property owner's property over an electronic environment. The computer implemented method disclosed herein is herein referred to as “return scheme”.

The property owner may log onto a real estate website hosted in the electronic environment. A real estate professional may be engaged to represent the property owner in the electronic environment. The real estate website may comprise a list of different real estate professionals that may be contracted by the property owner for the sale of the property. The property owner may engage the real estate professional by selecting the real estate professionals from the list of real estate professionals displayed on the real estate website. The property owner sets 101 a first list price for the property. The engaged real estate professional agrees 102 to the set first list price. To set the first list price, the property may be valuated in the electronic environment to generate a valuation price. The property owner may also engage an independent property valuator to valuate the property. The independent property valuator may generate the valuation price by estimating current market value of the property in the electronic environment. The property owner may determine the first list price of the property based on the generated valuation price. The determined first list price may be lower than the generated valuation price.

The real estate professional then sets 103 a second list price greater than the agreed upon first list price. The property owner and the real estate professionals enter 104 into a sales agreement. The sales agreement is an agreement to list the property of the property owner to a buyer at the second list price over the electronic environment. In the sales agreement, the property owner may appoint a main agent and one or more secondary agents for selling the property. The appointed main agent and the appointed secondary agents may enter into an agreement regarding the terms under which they will represent the property owner including the distribution of the fractions of the return between the main agent and the secondary agents. Alternatively, the property owner may appoint the real estate professional as a sole agent for exclusively representing the property.

The real estate professional then negotiates 105 the sale of the property of the property owner at the second list price between a buyer and the property owner based on the sales agreement. The real estate professionals may sell the property to the buyer at a price lower than the second list price. The property is sold 106 to the buyer based on the negotiation and the agreement reached between the buyer and the seller. The property may be sold with assistance from an attorney. The attorney may draw up a sale and purchase agreement between the property owner and the buyer for completing the sale. Completing the sale may comprise drawing of deeds, documents, etc. A return equal to the difference between the second list price and the first list price is remitted 107 to the real estate professional over the electronic environment. If the real estate professionals sell the property at a sale price below the second list price, the difference between the second list price and the sale price is deducted from the return remitted to the real estate professionals. The sale price is a price at which the property is sold to the buyer. The property may be sold at a sale price above the second list price in which case, the difference between the sale price and the second list price may be remitted to the real estate professional. Further, the property owner may sell the property below the second list price with or without assistance from the real estate professionals in which event, the difference between the second list price and the sale price is remitted to the real estate professional by the property owner.

The real estate professional may offer a concession to the buyer. This concession is forfeited from the return to the real estate professional. The property owner or real estate professional may also negotiate and sell the property at a sale price below the first list price in which case the difference between the sale price below the first list price and the second list price is remitted by the property owner to the real estate professional. This holds true in the case of “urgent sale” or “force sale” of the property by the property owner. In an “urgent sale” scenario, the property owner sets a second list price of which the real estate professional agrees to. Should the property owner sell the property at a sale price below the first list price, then the difference between the sale price below the first list price and the second list price shall be borne by the property owner as “return” to the real estate professional.

The remitted return may be distributed 108 among one or more real estate professionals in accordance with the sales or other agreement between the real estate professionals in the electronic environment. The real estate professionals may set multiple second list prices. Fractions of the return are distributed among one or more of the real estate professionals based on the set second list prices. The commission between the main agent and the secondary agent may be distributed in accordance with an agreement entered into between the main agent and the secondary agent. The payment of the commission in accordance with the return scheme negates payment of a commission by the property owner of the property to the real estate professional on the sale of the property.

Different fractions of the return may be computed for distribution to the real estate sales professional. For example, if the first list price is represented by “S”, the second list price by “Q”, and the return on the sale of the property payable to the real estate professionals is 5% of S, then Q may be computed using the formula “Q=S+S(0.05)”. Hence, the second list price is 105% of the first list price. The 5% return may be remitted to the main agent.

If the secondary agent is also involved in the negotiation of the sale, the return is divided between the main agent and the secondary agent according to an agreed upon ratio. For example, if the ratio is 50:50 and the return is 8% of the first list price, the second list price may be computed using the formula “Q=S+S(0.08)”. The main agent and the secondary agent are each remitted a return of 4% of S.

The return may also be a multi-tiered return. In a multi-tiered return, there may be more than one return, with each return divided among the real estate professionals in different ratios. The total return is the sum of the different returns. Multi-tiered returns arise if the first list price S is lower than the valuation price V. For example, a first return A may be computed from the difference between the first list price S and the valuation price V. A second return B may be computed from the difference between second list price Q and the valuation price V. The total return R is the sum of A and B. Return A may be shared in a 50:50 ratio between the main agent and the secondary agent, and return B may be shared in a 60:40 ratio between the main agent and the secondary agent.

Multi-tiered returns may also arise if the first list price S is equal to the valuation price V. The real estate professionals may set two second list prices Q1 and Q2. For example, Q1 may be 8% greater than S, and Q2 may be 10% greater than S. Then, the first return A is computed as the difference between Q1 and S, and the second return B is computed as difference between Q2 and Q1. The total return R is the sum of A and B. Return A may then be shared in a 50:50 ratio and return B may be shared in a 60:40 ratio. In addition to Q1 and Q2, the real estate professionals may also set a third list price Q3 greater than Q2.

The multi-tiered returns may further be extended to more than two real estate professionals, or to one or more third parties, for example, banks, subprime lenders, insurers, etc. Exemplary sharing ratios may be 40:40:20, 40:30:30 or 30:30:20:20, depending on the number of real estate professionals and other parties involved.

If the property is sold at a price lower than the second list price by a real estate professional or the property owner, the real estate professionals or the property owner compensate the real estate professional for the difference between the second list price and the sale price. For example, if the property owner agrees to sell the property to the buyer at a price lower than the second list price, the property owner has to reimburse the difference in price between the second list price and the sale price to the real estate professional. Return A is computed from the difference between first list price S and the second list price Q. A discounted return B is computed from the difference between the second list price Q and the discounted price D. The property owner compensates for the discounted return B to the real estate professionals. The property owner may compensate for the discounted return B by paying the attorney for completing the sale. The attorney may draw the sale and purchase agreement only after the property owner compensates for the discount given to the buyer. Hence, the return to the real estate professionals is assured even if the property is sold at a price below the second list price either directly by the owner of the property without assistance from the real estate professionals, or through the real estate professional with the consent of the property owner. Further, if any one of the third parties sells the property at a price less than the second list price to the buyer, the third party forfeits the difference between second list price and the sale price. The multi-tiered returns may also be applied when the property is sold at a price less than the second list price.

If a third party sells the property at a price P above the second list price Q, the first return A is the difference between Q and the first list price S, and the second return B is the difference between Q and P. The total return R is the sum of A and B. A and B may be divided among the real estate professionals and the third parties in different ratios. Each of the third parties may set a price above the second list price Q. Hence, there may be multiple list prices above Q, for example, P1, P2, P3, etc. The ratios for distribution of the return may be different for each of P1, P2, P3, etc. The ratio for the distribution depends on the price the property is sold at.

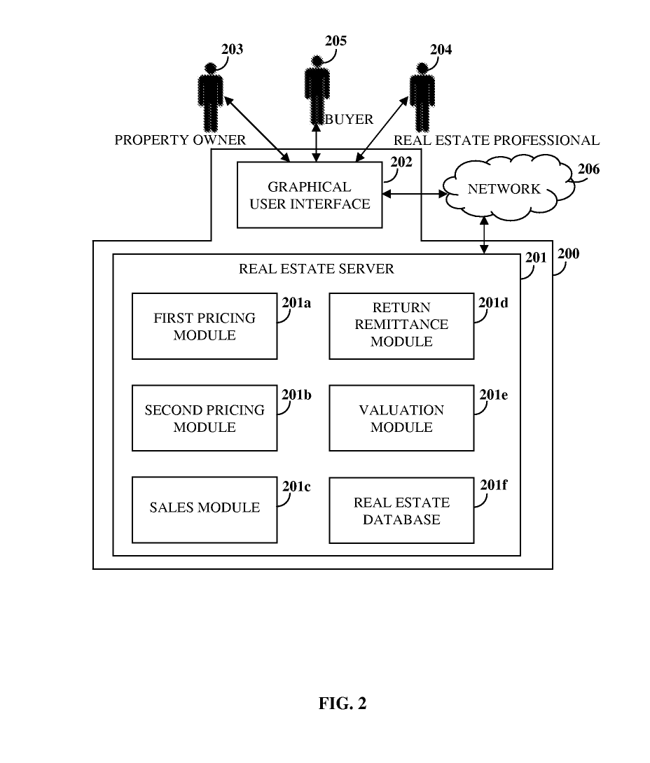

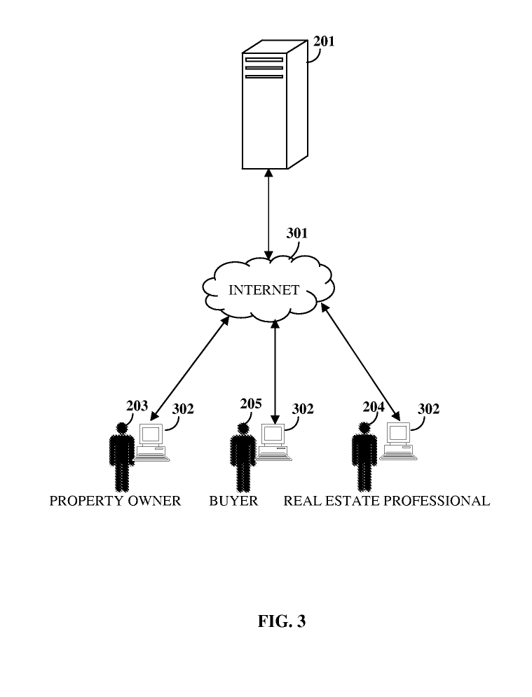

FIG. 2 illustrates a computer implemented system 200 for negating payment of a commission to a real estate professional 204 by a property owner 203 on sale of a property of the property owner 203 over an electronic environment. The system 200 disclosed herein comprises a real estate server 201 and a graphical user interface (GUI) 202. The real estate server 201 comprises a first pricing module 201a, a second pricing module 201b, a sales module 201c, a return remittance module 201d, a valuation module 201e, and a real estate database 201f. The property owner 203, the real estate professional 204, and a buyer 205 connect to the real estate server 201 through the GUI 202 via a network 206. The network 206 may, for example, be the internet 301. The property owner 203, the real estate professional 204, and the buyer 205 connected to the real estate server 201 via the internet 301 are exemplarily illustrated in FIG. 3.

The real estate professional 204, the property owner 203, and the buyer 205 connect to the real estate server 201 using a computing device 302 comprising two or more processors, memory, input devices, output devices, and network devices. The real estate professional 204, the property owner 203, and the buyer 205 provide inputs to the computing device 302 through a combination of the input devices, for example, a keyboard and a mouse. The processor processes the inputs and the computing device 302 provides outputs via a combination of output devices, for example, display devices, sound devices, etc. The computing device 302 communicates with other computing devices and the real estate server 201 over the network 206, for example, the internet 301, using the network devices.

The valuation module 201e valuates the property to generate a valuation price in the electronic environment. The first pricing module 201a determines a first list price of the property based on the generated valuation price. The first pricing module 201a enables the property owner 203 to set the first list price for the property. The real estate professional 204 agrees to the set first list price. The second pricing module 201b enables the real estate professional 204 to set a second list price greater than the agreed first list price. The GUI 202 enables the property owner 203 and the real estate professional 204 to enter into a sales agreement. The sales agreement is an agreement to list the property to the buyer 205 at the second list price over the electronic environment. The GUI 202 further enables the real estate professional 204 to negotiate a sale of the property at the set second list price between the buyer 205 and the property owner 203 based on the sales agreement. The GUI 202 further enables the property owner 203 to appoint a main agent and a secondary agent for selling the property. The GUI 202 also enables the appointed main agent and the appointed secondary agent to enter into an agreement regarding the terms under which they will represent the property owner 203.

The sales module 201c enables the sale of the property based on the negotiation. The return remittance module 201d remits a return equal to the difference between the second list price and the first list price to the real estate professional 204. The sales module 201c may enable the sale of the property at a sale price above the second list price. The difference between the sale price and second list price is also remitted to the real estate professional 204. The sales module 201c enables the property owner 203 to sell the property at a sale price below the second list price, wherein the property owner 203 remits the difference between the second list price and the sale price to the real estate professional 204.

Predetermined fractions of the remitted return may be distributed among one or more real estate professionals in the electronic environment. The return remittance module 201d determines the fractions of the return distributed between the main agent and the secondary agents. The remittance of the return eliminates payment of the commission by the seller of a property to the real estate professional 204.

The second pricing module 201b may also enable the real estate professional 204 to set multiple second list prices. Distributing of the return to the real estate professionals may be determined based on the second list prices. The GUI 202 may also enable the real estate professional 204 to offer a concession to the buyer 205. The concession is forfeited from the return by the real estate professional 204. The real estate database 201f stores a list of the real estate professionals, the predetermined fractions for distributing the returns, and a history of sales.

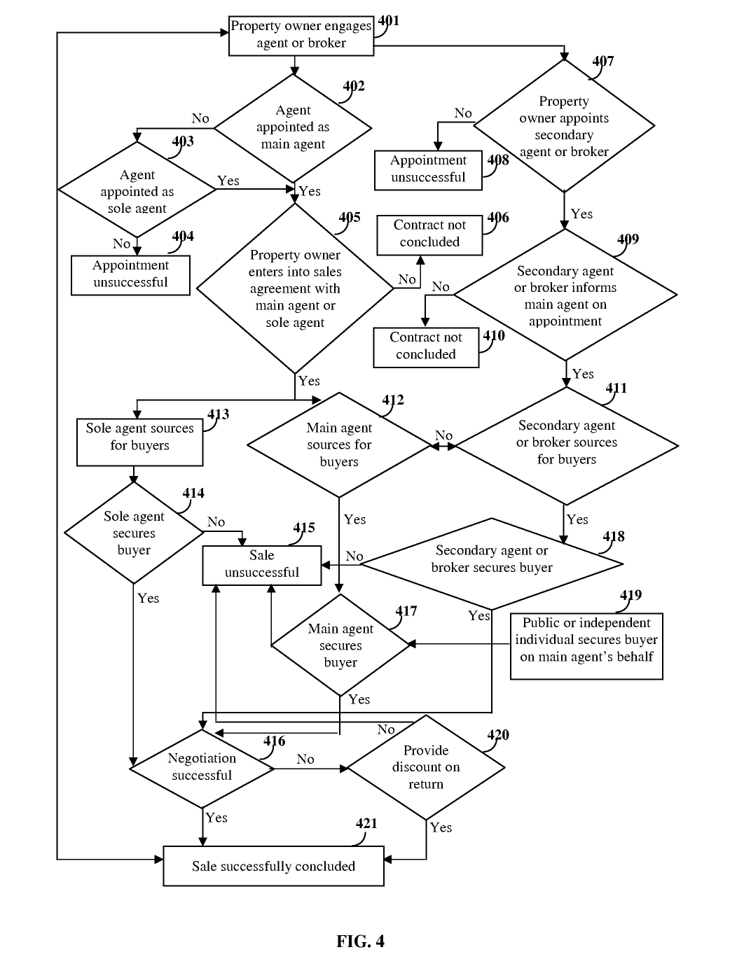

FIG. 4 exemplarily illustrates the steps involved in selling the property of the property owner 203 by the real estate professional 204. The property owner 203 engages 401 the real estate professional 204 as an agent or a broker. The agent may be appointed 402 as a main agent. The agent may also be appointed 403 as a sole agent. The appointment may be unsuccessful 404. The property owner 203 enters 405 into a sales agreement with the main agent or the sole agent. The contract is not concluded 406 if the sales agreement is not entered into. The property owner 203 may also appoint 407 a secondary agent or broker. The appointment may be unsuccessful 408. The secondary agent or broker informs 409 the main agent about the appointment. If the secondary agent or broker does not inform the main agent, the contract is not concluded 410. The main agent sources 412 for buyers. The sole agent may also source 413 for buyers. The secondary agent may further source 411 for buyers. The main agent may secure 417 the buyer 205, the sole agent may secure 414 the buyer 205, or the secondary agent may secure 418 the buyer 205. A member of the public or an independent individual may also secure 419 the buyer 205 on the main agent's behalf. If negotiation is not successful 416, a discount on the return may be provided 420. If the discount is not provided, the sale may be unsuccessful 415. If the negotiation is successful 416 or the discount is provided, the sale may be successfully concluded 421.

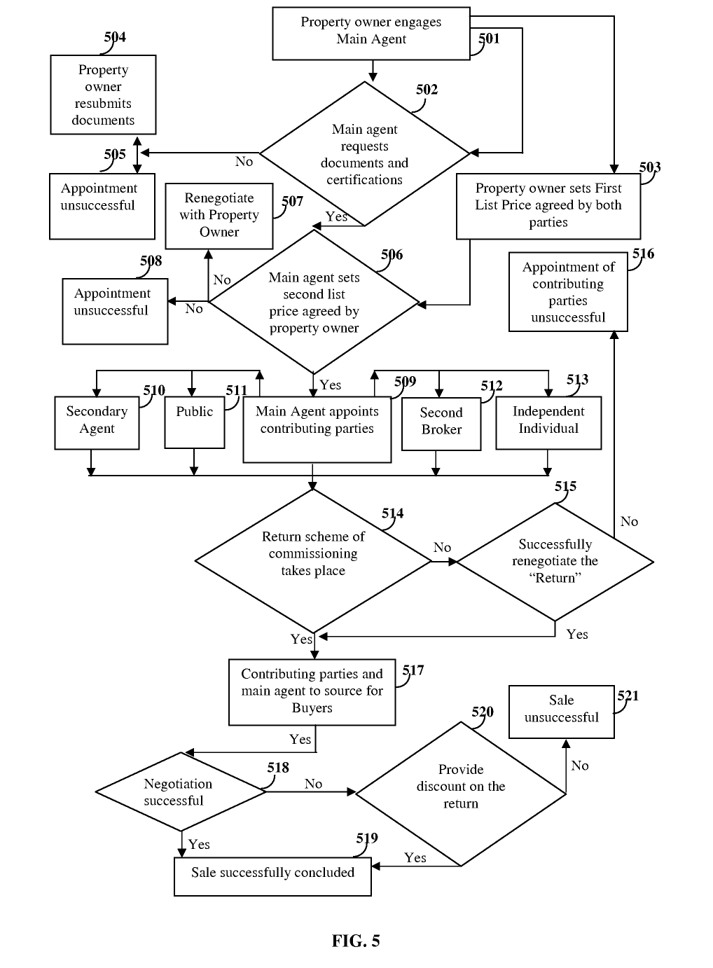

FIG. 5 exemplarily illustrates the steps involved in selling the property of the property owner 203 by a main agent with involvement of contributing parties. The property owner 203 engages 501 a real estate professional 204 as a main agent. The property owner 203 sets 503 a first list price for the property. The main agent requests 502 for documents and certifications of the property. If the main agent has not received the documents and certifications, the property owner 203 may resubmit 504 documentation and certifications. If the property owner 203 does not resubmit the documents and certifications, the appointment may be unsuccessful 505. If the property owner 203 has submitted the documents and certifications, the main agent sets 506 the second list price. The main agent may renegotiate 507 with the property owner 203 for the second list price, or the appointment may be unsuccessful 508.

If the appointment is successful, the main agent appoints 509 contributing parties for the sale. The contributing parties may, for example, be a secondary agent 510, a second broker 512, an independent individual 513, or members of the public 511. The fractions for distributing the return are decided 514. The fractions may be renegotiated 515. If the renegotiation is unsuccessful, the appointment of the contributing parties is unsuccessful 516. If the appointment is successful, the agents, brokers, and the contributing parties source 517 for the buyers. The sale is negotiated 518. If the negotiation is successful, the sale is successfully concluded 519. If the negotiation is unsuccessful, a discount on the return may be provided 520 to the buyer 205 to successfully conclude 519 the sale. If the discount is not provided 520, the sale is unsuccessful 521.

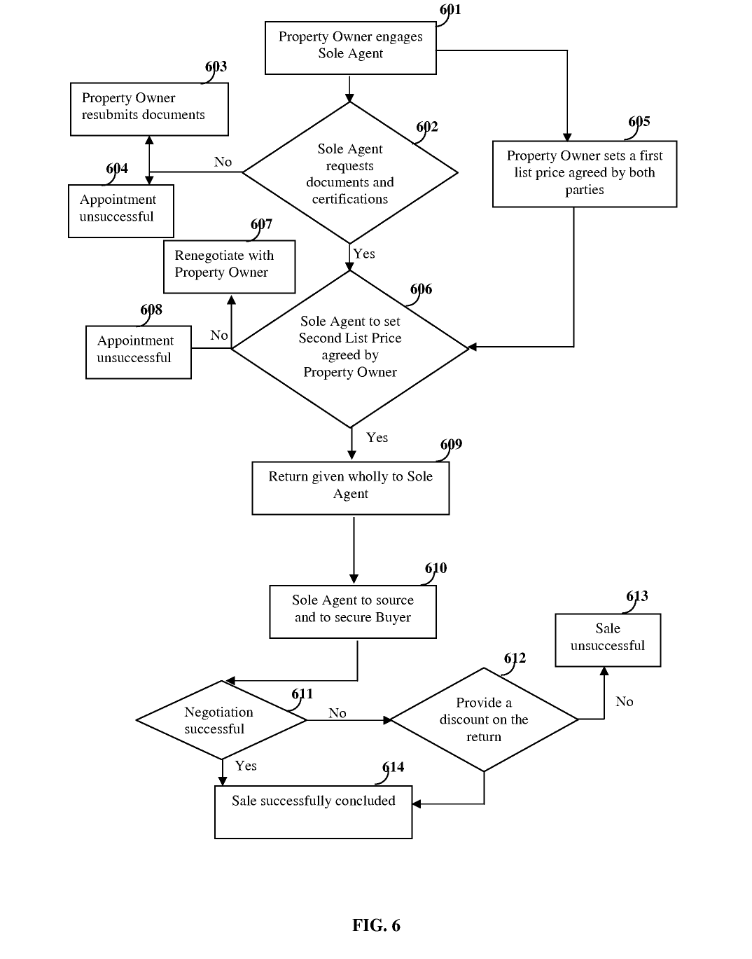

FIG. 6 exemplarily illustrates the steps involved in selling the property of the property owner 203 by a sole agent appointed by the property owner 203. The property owner 203 engages 601 a real estate professional 204 as a sole agent. The sole agent may request 602 for documents and certifications pertaining to the property. If the property owner 203 has not submitted the documents and certifications, the property owner 203 may resubmit 603 the documents and certifications to the sole agent. If the property owner 203 does not submit the documents and certifications, the appointment may be unsuccessful 604. The property owner 203 sets 605 a first list price that the sole agent agrees to. The sole agent sets 606 a second list price that the property owner 203 agrees to. If the property owner 203 does not agree to the second list price, the sole agent may renegotiate 607 with the property owner 203. If the sole agent does not renegotiate 607 with the property owner 203, the appointment may be unsuccessful 608. If the property owner 203 agrees to the second list price, the property owner 203 and the sole agent agree to give 609 the return wholly to the sole agent. The sole agent sources and secures 610 the buyer 205. Once the buyer 205 is secured, the sole agent negotiates the sale. If the negotiation is successful 611, the sale is successfully concluded 614. If the negotiation is unsuccessful 611, the sole agent may provide 612 a discount on the return to successfully conclude 614 the sale. If the sole agent does not provide 612 a discount on the return, the sale is unsuccessful 613.

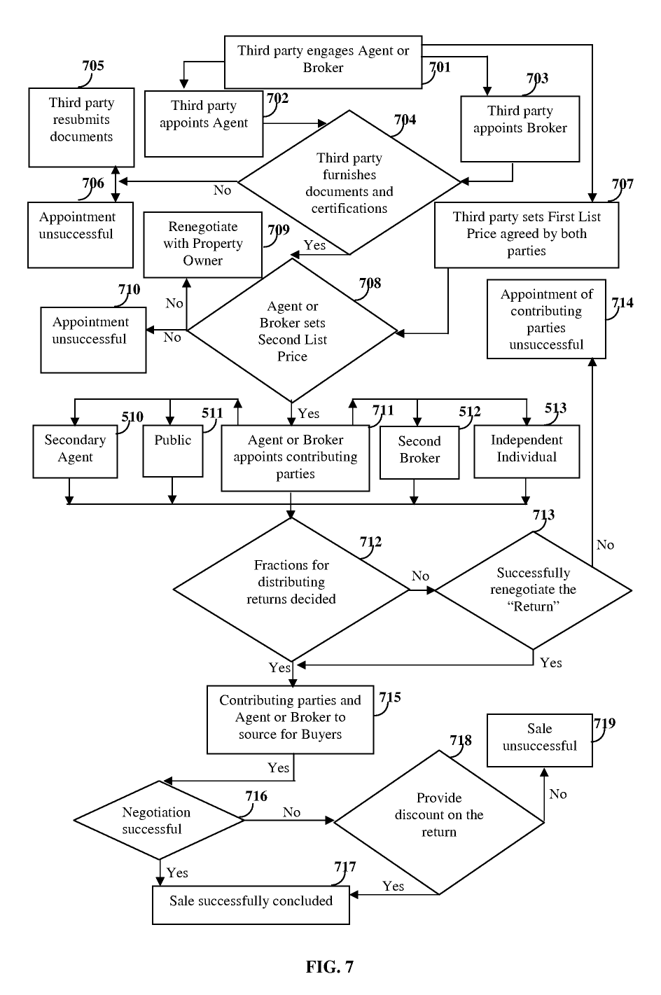

FIG. 7 exemplarily illustrates the steps involved in selling the property of the property owner 203 with the involvement of a third party, for example, a bank or a mortgage company. The third party engages 701 a real estate professional 204 as an agent or a broker. The third party appoints 702 an agent for the sale of the property. The third party may also appoint 703 a broker for the sale of the property. The third party furnishes 704 documentation and certifications. If the third party has not submitted the documents and certifications, the third party may resubmit 705 the documents and certifications. If the third party does not submit the documents and certifications, the appointment may be unsuccessful 706. If the third party has submitted the documents and certifications, the agents and brokers set 708 the second list price. The agents and brokers may renegotiate 709 with the property owner 203 for the second list price, or the appointment may be unsuccessful 710.

If the appointment is successful, the agents and brokers appoint 711 contributing parties for the sale. The contributing parties may, for example, be a secondary agent 510, a second broker 512, an independent individual 513, or members of the public 511. The fractions for distributing the return are decided 712. The fractions may be renegotiated 713. If the renegotiation is unsuccessful, the appointment of the contributing parties is unsuccessful 714. If the appointment is successful, the agents, brokers, and the contributing parties source 715 for buyers. The sale is negotiated. If the negotiation is successful 716, the sale is successfully concluded 717. If the negotiation is unsuccessful 716, a discount on the return may be offered 718 to the buyer 205 to successfully conclude 717 the sale. If the discount is not offered 718, the sale is unsuccessful 719.

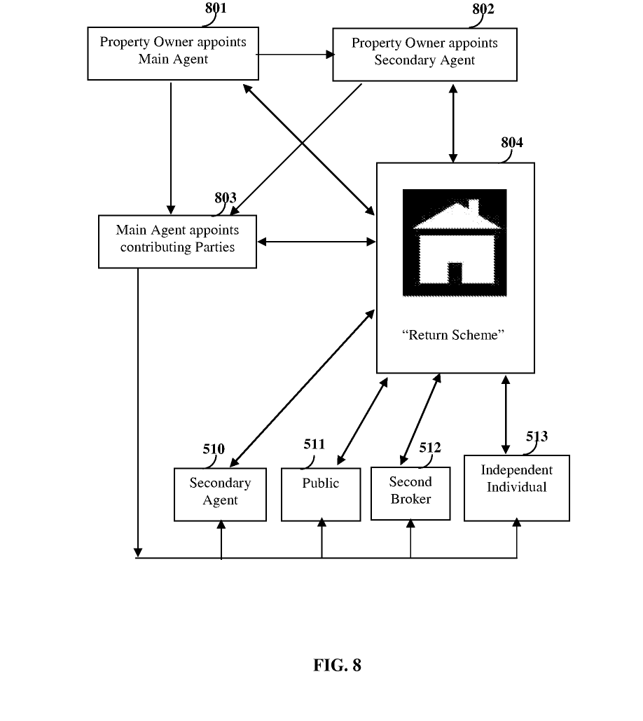

FIG. 8 exemplarily illustrates a schematic representation of appointment of different real estate professionals. The property owner 203 appoints 801 a main agent. The property owner 203 also appoints 802 a secondary agent. The main agent appoints 803 the contributing parties. The contributing parties may, for example, be a secondary agent 510, a second broker 512, an independent individual 513, or members of the public 511. The contributing parties may be appointed in any combination. The property owner 203, the real estate professional 204, and the contributing parties use the return scheme 804 for the sale of the property, the distribution of the return, and the elimination of payment of the commission.

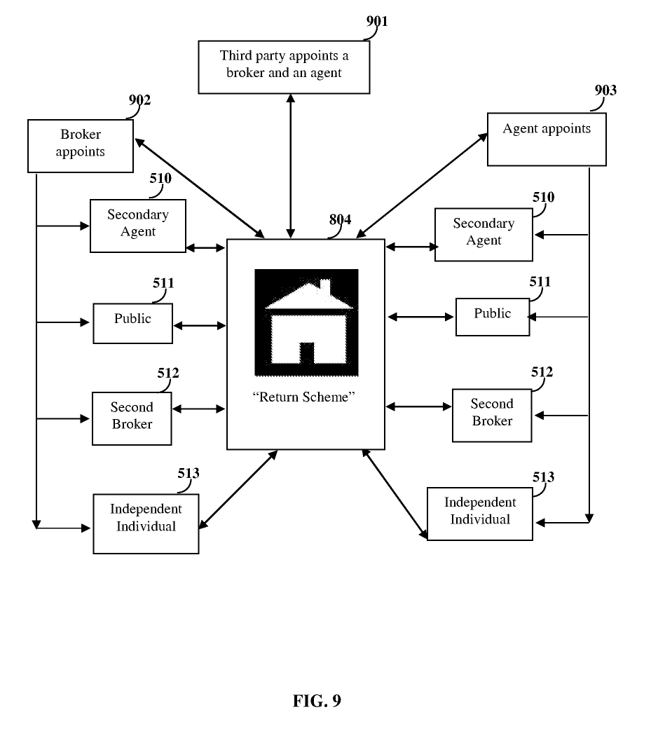

FIG. 9 exemplarily illustrates a schematic representation of sale of the property of the property owner 203 with the involvement of a third party, for example, a bank or a mortgage company. The bank or the mortgage company appoints 901 a broker and an agent. The broker appoints 902 the contributing parties. The contributing parties may, for example, be a secondary agent 510, a second broker 512, an independent individual 513, or members of the public 511. The agent may also appoint 903 the contributing parties.

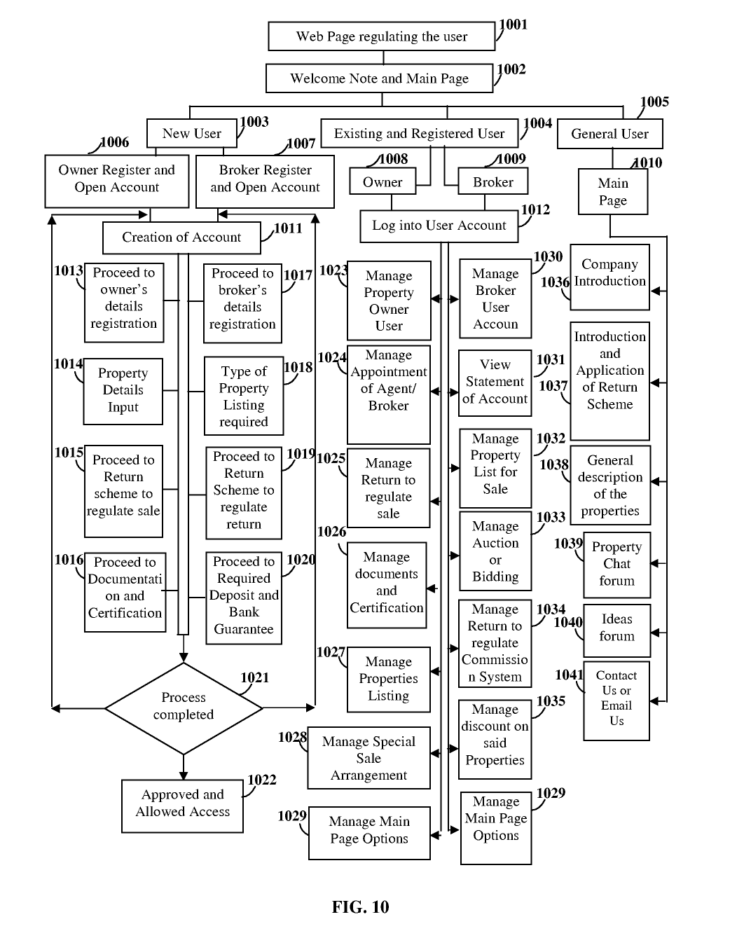

FIG. 10 exemplarily illustrates the steps involved in selling the property of the property owner 203 via the internet 301. A user visits a real estate website hosted on the real estate server 201. The user may, for example, be the property owner 203, the real estate professional 204, or the buyer 205. In this example, the real estate professional 204 is a broker. The user enters the real estate website via a web page regulating 1001 different users. The user is presented a welcome note and a main page 1002. If the user has not created an account with the real website earlier, the user is presented with a New User webpage 1003. The user may select owner registration 1006 or broker registration 1007. The user creates 1011 an account. If the user is the property owner 203, the user provides property owner details 1013. The user then provides property details 1014. The user proceeds 1015 to the return scheme to regulate the sale of the property. The user then provides 1016 documentation and certification for the sale. When the process is completed 1021, the user is approved and allowed access 1022 to the real estate website. If the user is a broker, the user provides broker details 1017. The user then selects 1018 type of property required. The user proceeds 1019 to the return scheme too regulate the return. The user then provides 1020 a required deposit and a bank guarantee. When the process is completed 1021, the user is approved and allowed access 1022 to the real estate website.

The user may have previously registered 1004 and created an account at the real estate website. The user logs in via an owner login 1008 if the user is a property owner 203 and via a broker login 1009 if the user is a broker. The user is logged into 1012 the user's account. If the user is a property owner 203, the user is permitted to manage 1023 a property owner account. The user then manages 1024 appointment of the broker or the agent. The user then manages 1025 the return to regulate the sale. The user further manages 1026 documentation and certification for the sale. The user manages 1027 property listings, where the user may add or modify property details. The user may also manage 1028 special sale arrangements, for example, selling the property without assistance from the broker or agent. The user may further manage 1029 main page options, wherein the user configures the look, feel, and content of the main page of the real estate website presented when the user logs in.

If the user is a broker, the user is permitted to manage 1030 a broker account. The user may be permitted to view 1031 a statement of the user account. The user may manage 1032 a property list for sale. The property list may comprise multiple properties available for sale. The user may manage 1033 an auction or bidding process for different sales negotiated or handled by the broker. The user manages 1034 the return scheme for the sale. The user may further manage 1035 a discount given for the property. The user may also manage 1029 the main page options.

If the user is not a property owner 203, a broker, or a buyer 205, the user is presented 1010 with a main page. The main page may provide the user photographs of different properties available and a description of different properties wanted. The user may then access an introduction 1036 to the real estate website, an introduction 1037 to the return scheme, a general description 1038 about the properties, a property chat forum 1039, an ideas forum 1040, and contact information 1041 of administrators and business managers of the real estate website.

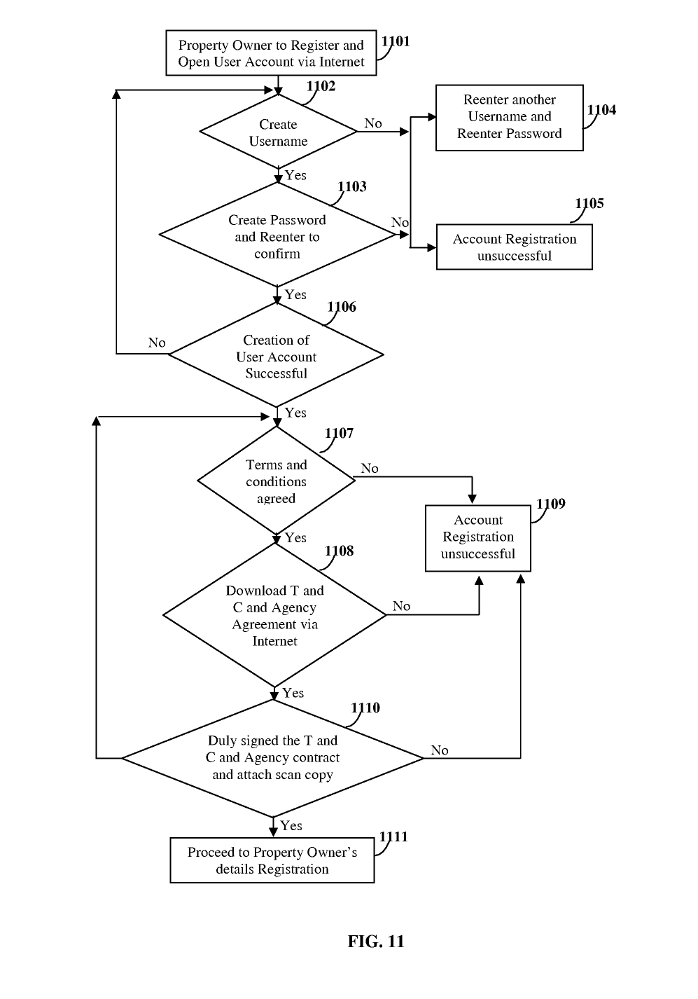

FIG. 11 exemplarily illustrates the steps involved in the registration of the property owner 203 with the real estate website. The property owner 203 registers 1101 with the real estate website and creates a user account. The property owner 203 creates 1102 a username. The property owner 203 then creates 1103 a password. If the username or the password is not valid, the property owner 203 reenters 1104 another username and password. If the property owner 203 does not reenter the username and password, the account registration is unsuccessful 1105. If the creation of user account is successful 1106 and if the property owner 203 agrees 1107 to terms and conditions laid down by the real estate website, the property owner 203 may download 1108 the terms and conditions from the real estate website. If the property owner 203 does not agree to the terms and conditions or does not download the terms and conditions the account registration may be unsuccessful 1109. The property owner 203 signs 1110 the terms and conditions contract and provides a copy of the signed terms and conditions. If the property owner 203 does not sign the terms and conditions or does not provide a copy of the signed terms and conditions, the account registration may be unsuccessful 1109. If the account registration is successful, the property owner 203 proceeds 1111 to provide property owner details.

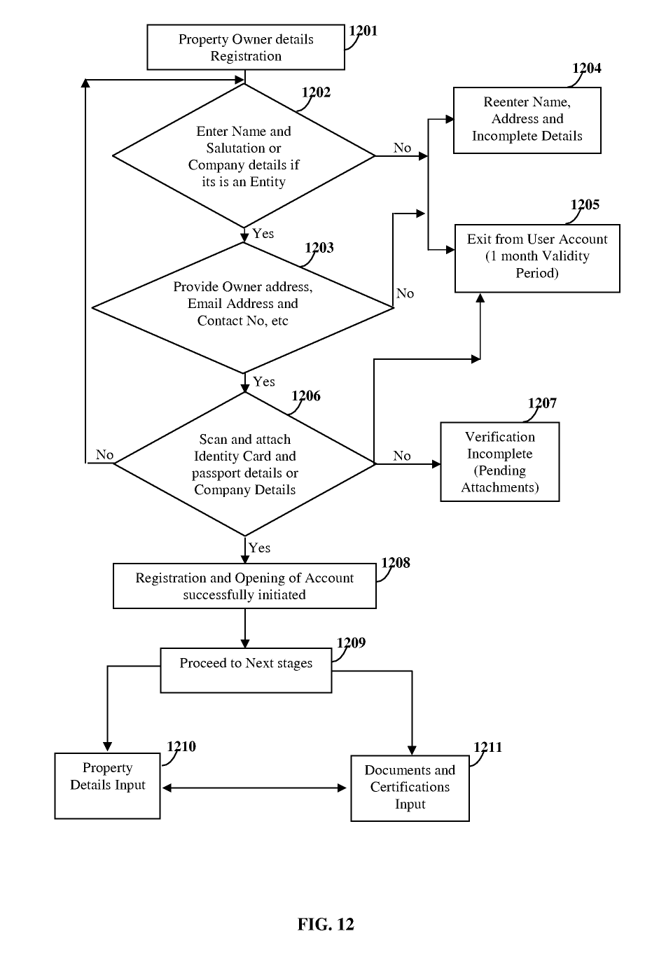

FIG. 12 exemplarily illustrates the steps involved in the property owner 203 providing the property owner details on the real estate website. The property owner 203 registers 1201 on the property owner details web page. The property owner 203 enters 1202 name and salutation, with company name if the property is registered to a company. The property owner 203 may provide 1203 contact details, for example, address, email address, phone number, etc. The property owner 203 may scan and attach 1206 identity card or passport or company details. The property owner 203 may have to reenter 1204 name, address, etc., if entered incorrectly. The property owner 203 may exit 1205 from the user account. The user account may have a 1 month validity period. The verification may be incomplete 1207 if the attachments are pending. Hence, registration and opening of account by the property owner 203 is successfully initiated 1208. The property owner 203 may proceed 1209 to the next stages to input 1210 property details or input 1211 documents and certifications.

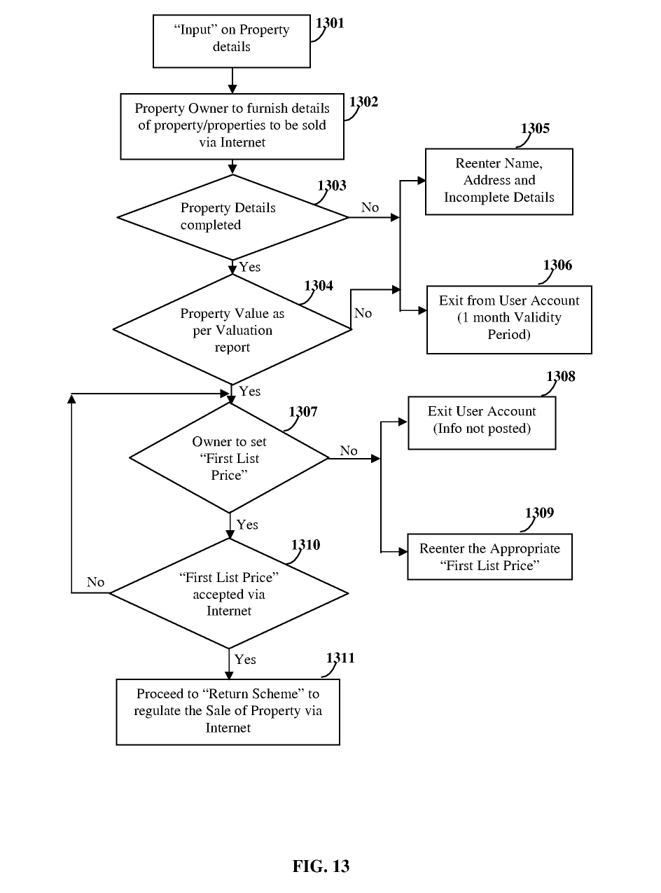

FIG. 13 exemplarily illustrates the steps involved in providing property details on the real estate website. The property owner 203 provides 1301 inputs on the property details. The property owner 203 furnishes 1302 details about the property. If the property details are not completed 1303, the property owner 203 may reenter 1305 name, address, and other incomplete details. The property value is checked 1304 against the valuation price on a valuation report. If the property value is as per valuation price, the property owner 203 sets 1307 a first list price for the property. The first list price may be accepted 1310 on the real estate website. The property owner 203 then proceeds 1311 to the return scheme to regulate the sale of the property. If the property value is not as per the valuation price, the property owner 203 may exit 1306 from the user account. The user account may have a 1 month validity period. If the property owner 203 does not set the appropriate first list price, the property owner 203 may exit 1308 the user account or may reenter 1309 an appropriate first list price.

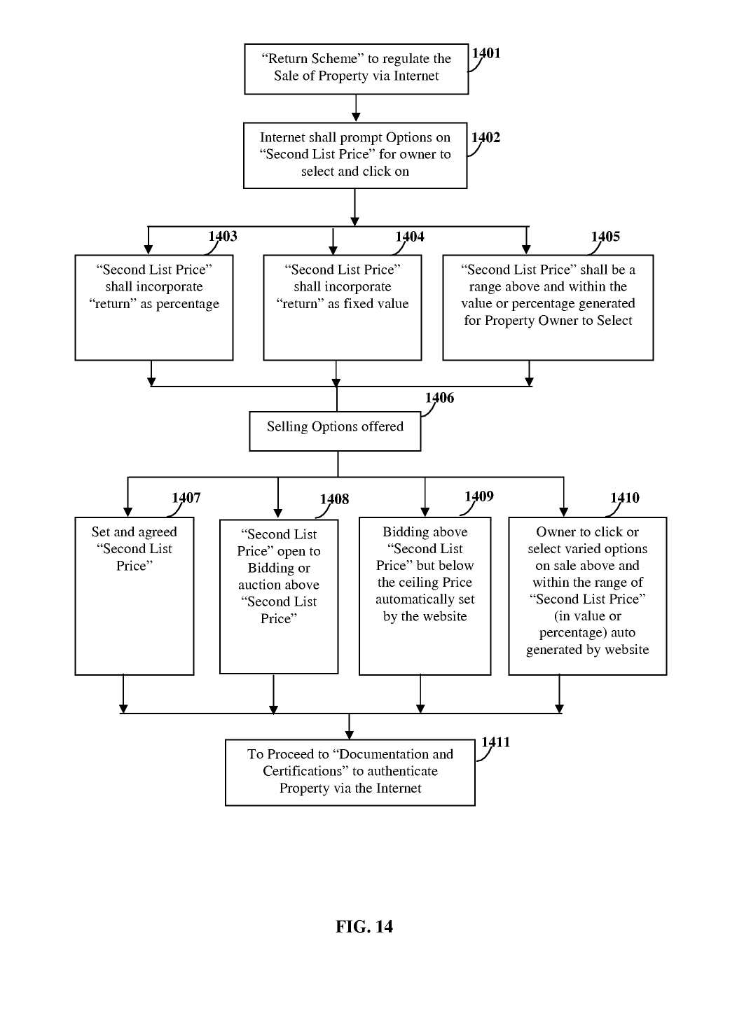

FIG. 14 exemplarily illustrates the steps involved in regulating the sale of the property using the return scheme via the internet 301. The property owner 203 proceeds 1401 to the return scheme to regulate the sale of the property on the real estate website via the internet 301. The real estate website prompts 1402 the user on different second list prices offered by different real estate professionals. The second list prices may incorporate the return as a percentage 1403 of the first list price, as a fixed value 1404 above the first list price, or as a range 1405 above and within the value or percentage offered by the real estate website. The real estate website offers 1406 different selling options to the property owner 203. The second list price may be set and agreed 1407. The second list price may also be open to bidding and auction 1408. The second list price may be open to bidding but limited 1409 to a ceiling price automatically generated by the real estate website. Further, the property owner 203 may select the second list price above and within a range generated by the real estate website 1410. Upon completion, the property owner 203 may then proceed 1411 to provide documents and certifications of the property to authenticate the property via the internet 301.

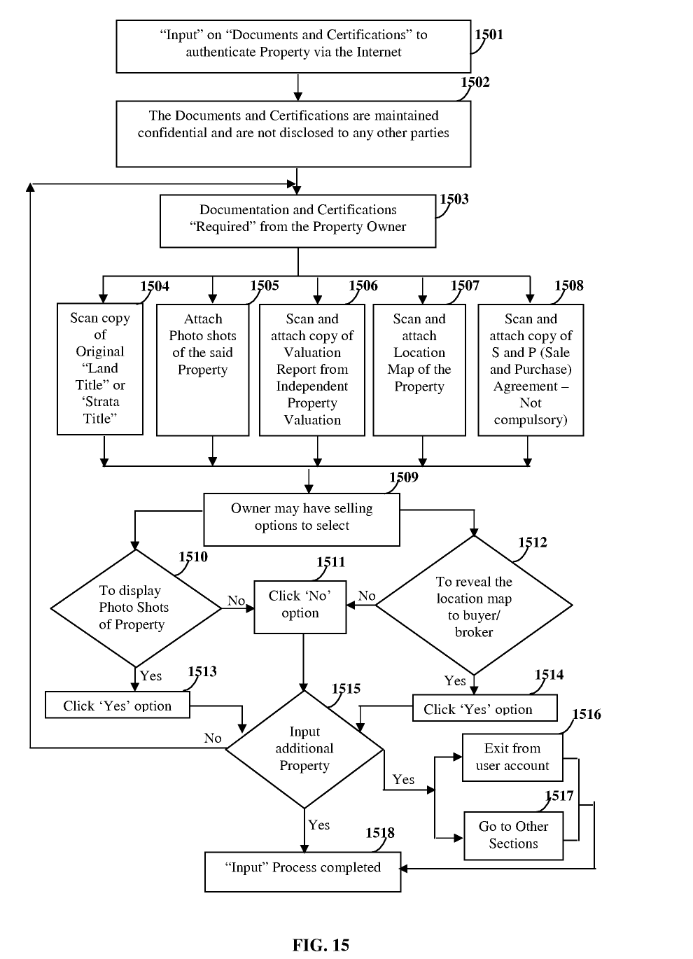

FIG. 15 exemplarily illustrates the steps involved in providing documents and certification by the property owner 203 for the sale of the property. The property owner 203 provides 1501 inputs on the documents and certification to authenticate the property. The documents and certifications are maintained confidential and are not disclosed 1502 to any other person by the real estate website. The documents and certifications are required 1503 from the property owner 203. The property owner 203 may scan and attach 1504 a copy of land title for the property. The property owner 203 may attach 1505 photographs of the property. The property owner 203 may scan and attach 1506 a copy of the valuation report comprising the valuation price. The property owner 203 may further scan and attach 1507 a location map for the property. Optionally, the property owner 203 may also attach scan and attach 1508 a copy of the sale and purchase agreement. The real estate website provides 1509 the property owner 203 selling options to select from. The real estate website provides the property owner 203 an option 1510 to display photographs of the property. The property owner 203 may select “yes” 1513 or “no” 1511. The real estate website also provides the property owner 203 an option 1512 to reveal the location map for the property. The property owner 203 may select “yes” 1514 or “no” 1511. The property owner 203 may then be provided an option 1515 to input additional property. The property owner 203 may exit 1516 from the user account or go to 1517 a different section of the website. The input process is then completed 1518.

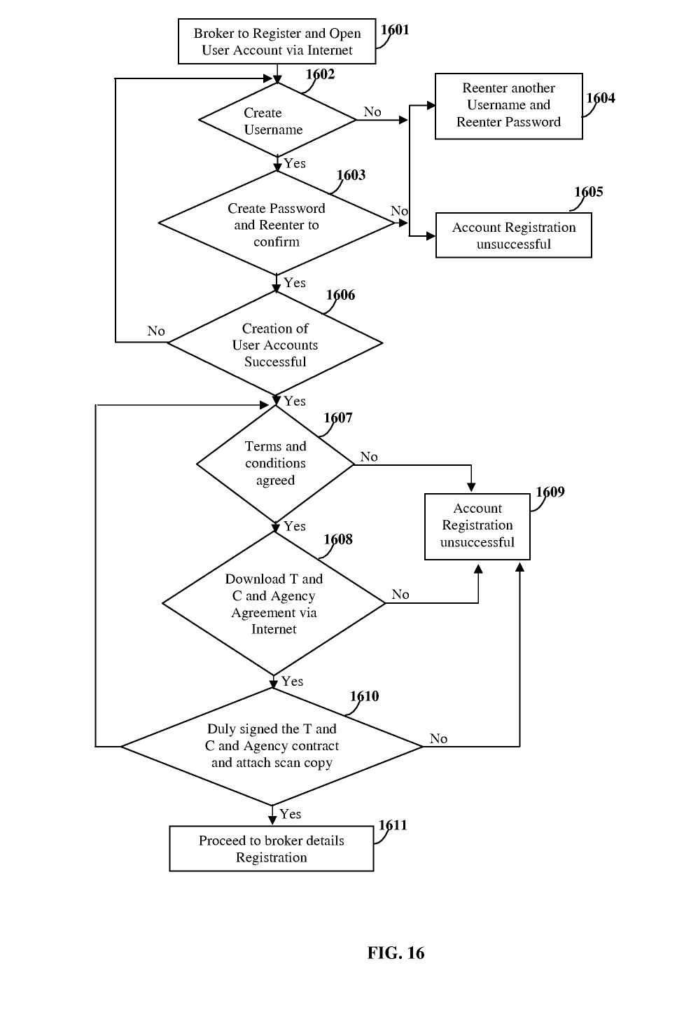

FIG. 16 exemplarily illustrates the steps involved in the registration of the broker with the real estate website. The broker registers 1601 with the real estate website and creates a user account. The broker creates 1602 a username. The broker then creates 1603 a password. If the username or the password is not valid, the broker reenters 1604 another username and password. If the broker does not reenter the username and password, the account registration is unsuccessful 1605. If the creation of user accounts is successful 1606 and if the broker agrees 1607 to terms and conditions laid down by the real estate website, the broker may download 1608 the terms and conditions from the real estate website. If the broker does not agree to the terms and conditions or does not download the terms and conditions the account registration may be unsuccessful 1609. The broker signs 1610 the terms and conditions contract and provides a copy of the signed terms and conditions. If the broker does not sign the terms and conditions or does not provide a copy of the signed terms and conditions, the account registration may be unsuccessful 1609. If the account registration is successful, the broker proceeds 1611 to provide broker details.

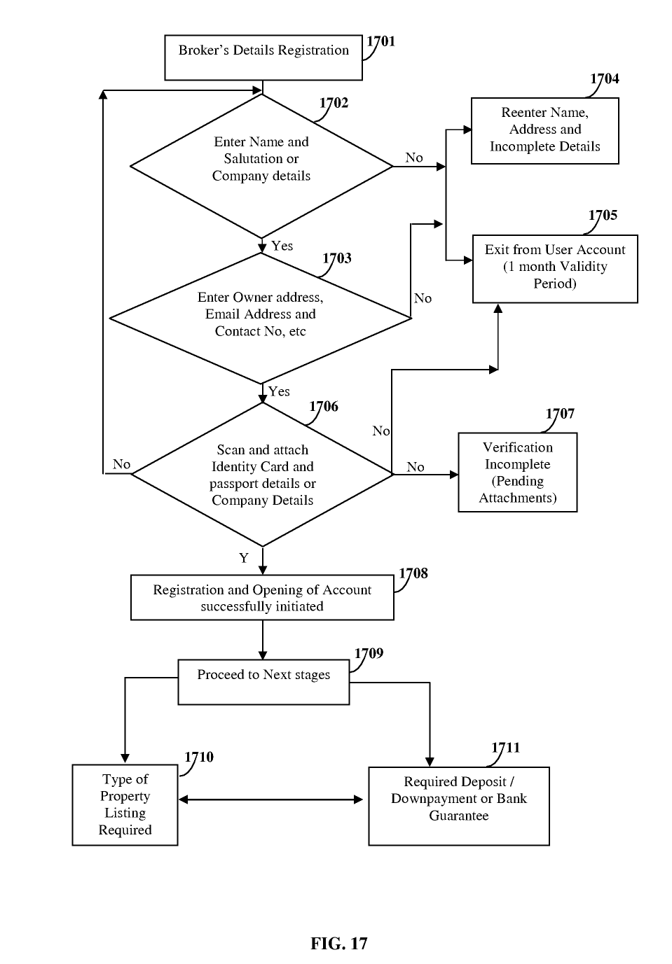

FIG. 17 exemplarily illustrates the steps involved in the broker providing broker details on the real estate website. The broker proceeds 1701 to register the broker details. The broker enters 1702 name and salutation or company name if the broker is a company. The broker enters 1703 name, address, contact number, etc. If the details are incomplete, the broker may reenter 1704 the details. If the broker does not reenter the details, the broker is exited 1705 from the user account. The broker may further scan and attach 1706 identity card and passport details or company details. If the broker does not scan and attach the details, the verification is incomplete 1707 due to pending attachments. If the verification is complete, the registration and opening of the user account is successfully initiated 1708. The broker may then proceed 1709 to provide information on the type of property listing required 1710 by the broker. The broker may also proceed 1709 to provide 1711 the bank guarantee and required deposit.

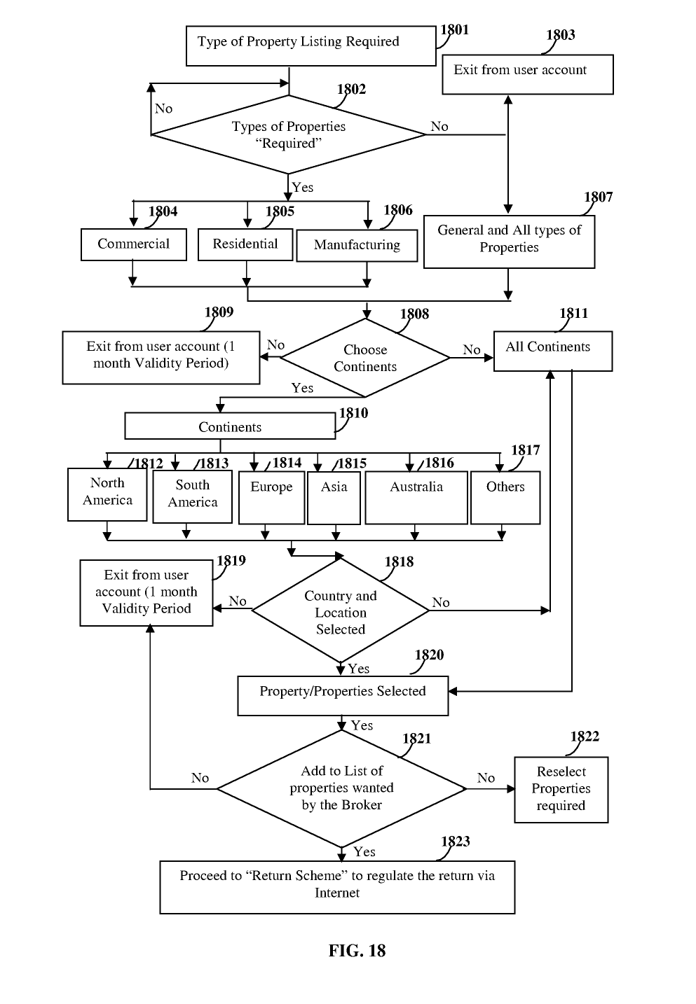

FIG. 18 exemplarily illustrates the steps involved in the broker providing information on the type of property listing required by the broker on the real estate website. The user proceeds 1801 to a property listing required information web page. The broker provides 1802 type of property listing required. The broker may categorize the required listing into commercial 1804, residential 1805, manufacturing 1806, and general 1807. The broker may also exit 1803 form the user account. The broker may be provided an option 1808 to choose continents for the required property. If the broker does not provide continents, the broker may exit 1809 from the user account. The broker may choose 1810 the continents. The continents may, for example, be North America 1812, South America 1813, Europe 1814, Asia 1815, Australasia 1816, Others 1817, or All Continents 1811. The broker may then select 1818 country and location within the chosen continents. The broker may then select 1820 properties within the selected country and location to add 1821 to a list of properties required by the broker. The broker may exit 1819 from the user account. The broker may also reselect 1822 properties required. The broker then proceeds 1823 to regulate the return from the sale using the return scheme.

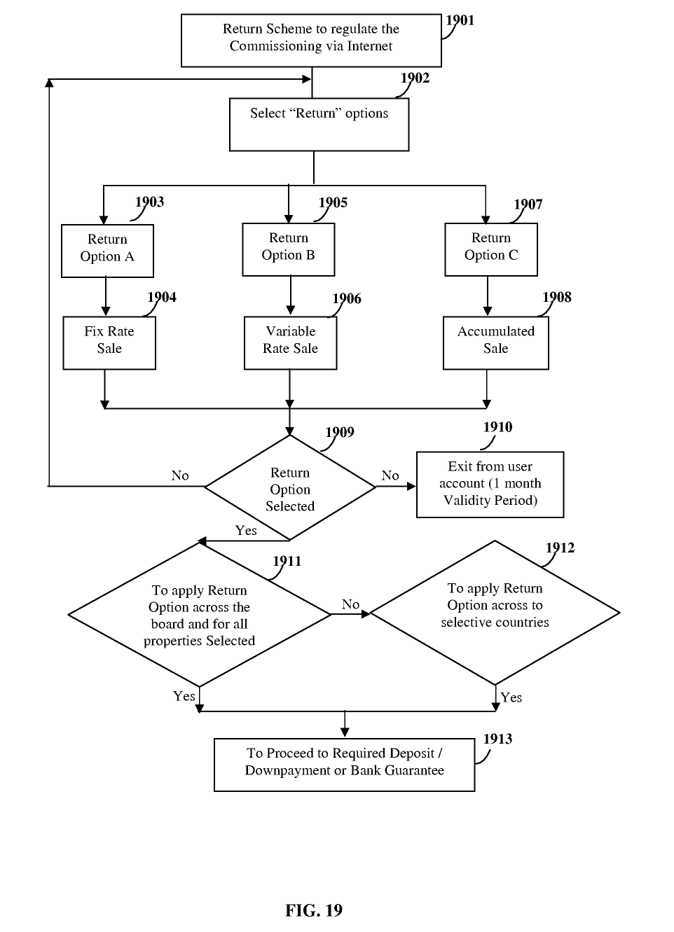

FIG. 19 exemplarily illustrates the steps involved in regulating the return by the broker on the real estate website. The broker proceeds 1901 to a return regulation web page. The real estate website provides 1902 different return options, for example, return option A 1903, return option B 1905, and return option C 1907. Return option A 1903 may be a fixed rate sale 1904, wherein a flat return rate, for example, 35%, is fixed. Return option B 1905 may be a variable rate sale 1906, wherein the return rate varies with the sale price. Return option C 1907 may be an accumulated sale 1908, wherein the return rate is based on multiple sales and sale prices of each of the sales. The return rate for each of the sales may be different. The broker selects 1909 the return option. If the broker does not select the return option, the broker may exit 1910 from the user account. The broker may then choose to apply 1912 the return option for sales only in selective countries or to apply 1911 the return scheme irrespective of the country of sale. The broker may then proceed to provide 1913 the bank guarantee and required deposit.

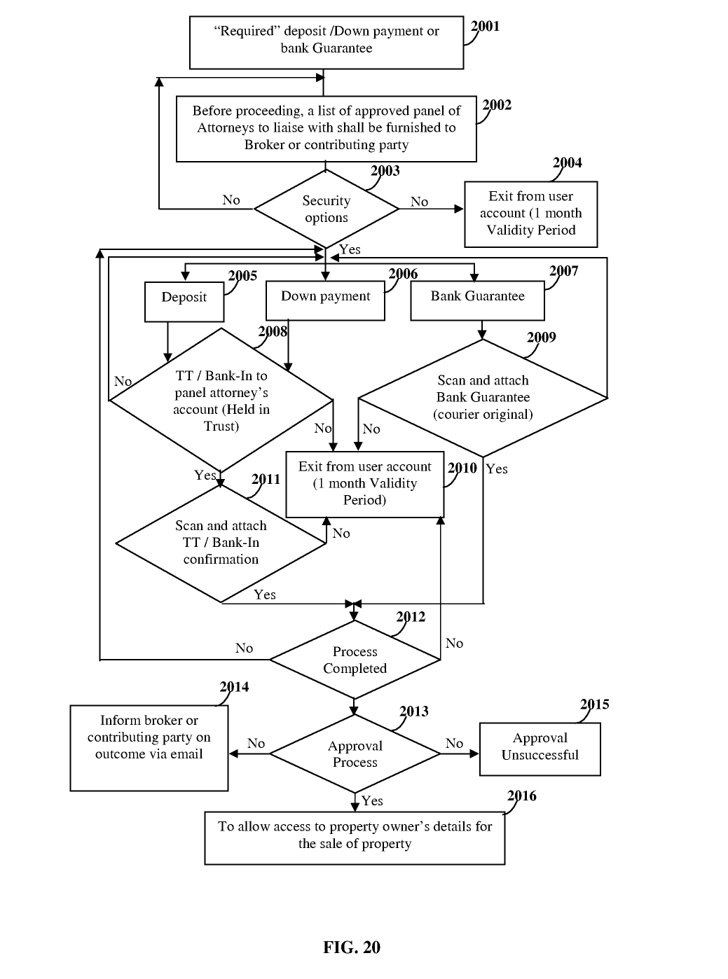

FIG. 20 exemplarily illustrates the steps involved in the broker providing the bank guarantee and required deposit on the real estate website. The broker is required to provide the bank guarantee and down payment 2001. A list of attorneys the broker may liaise with is provided 2002 to the broker. The real estate website provides 2003 the broker multiple security options. The security options may be deposit 2005, down payment 2006, or bank guarantee 2007. If the broker does not select any of the security options, the broker may exit 2004 from the user account. If the broker selects deposit or down payment, the deposit or the down payment is transferred 2008 to a bank account of the attorney who holds the deposit or down payment in trust. The broker may scan and attach confirmation 2011 of the transfer. If the broker selects bank guarantee, the broker may scan and attach 2009 the bank guarantee. The original copy of the bank guarantee may be sent via courier by the broker at a later point in time. The broker may exit 2010 from the user account. The security providing process is completed 2012. The security needs to go through an approval process 2013. The approval process may be successful or unsuccessful 2015. The broker may be informed 2014 of the outcome of the approval process via electronic mail (email). The real estate website then allows 2016 the broker to access the property listing of the property owner 203 in the real estate website.

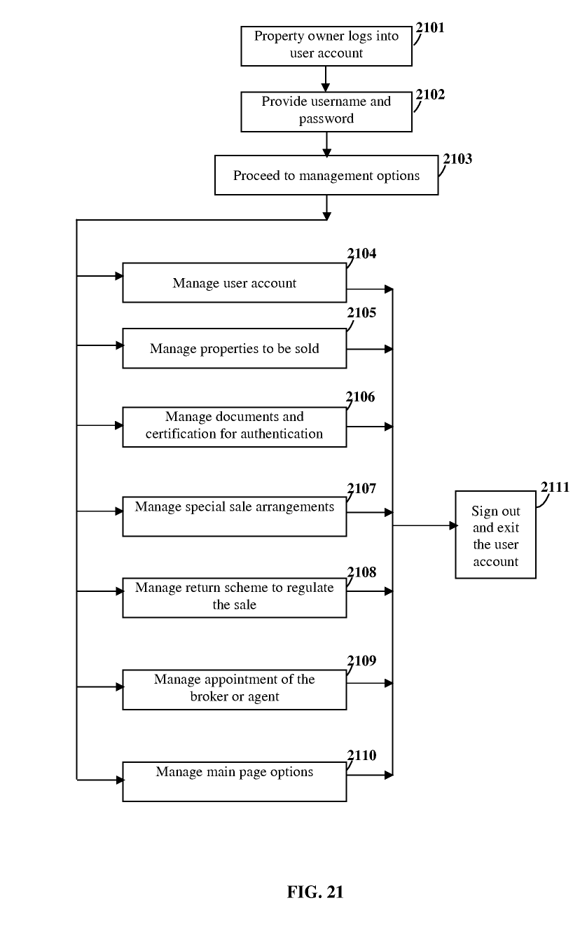

FIG. 21 exemplarily illustrates the steps involved in the property owner 203 accessing management options provided by the real estate website. The property owner 203 logs in 2101 to the user account by providing 2102 username and password. The property owner 203 then proceeds 2103 to multiple management options provided by the real estate website. The property owner 203 may manage 2104 the user account, manage 2105 properties to be sold, manage 2106 documents and certifications for authentication, manage 2107 special sale arrangement, manage 2108 the return scheme for regulating the sale, manage 2109 appointment of the broker or agent, and manage 2110 main page options. The user may sign out of and exit 2111 the user account.

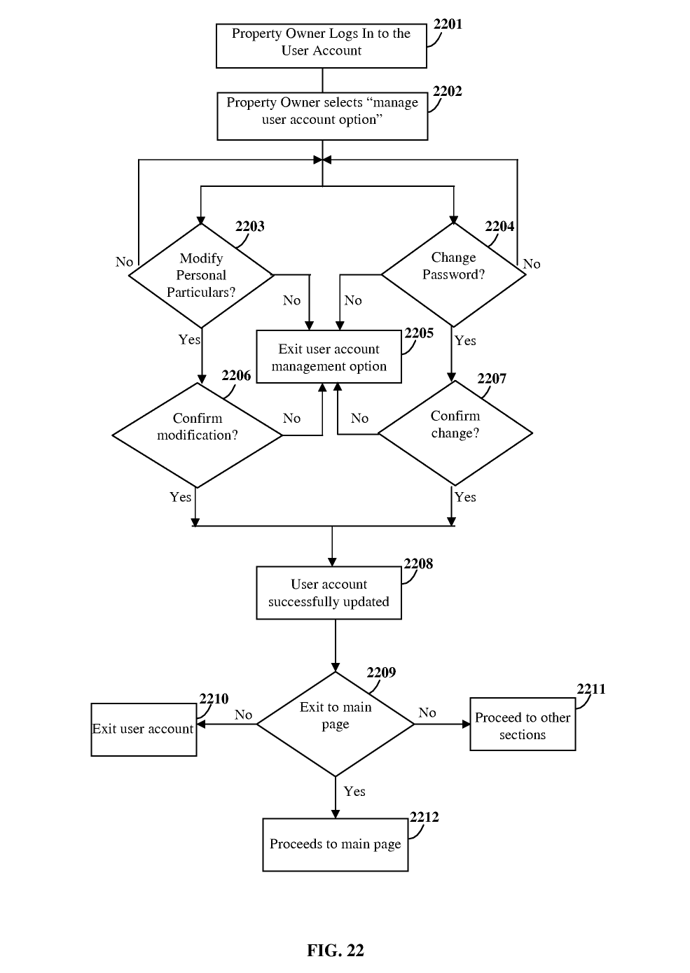

FIG. 22 exemplarily illustrates the steps involved in the property owner 203 managing the property owner's 203 user account on the real estate website. The property owner 203 logs in 2201 to the user account and selects 2202 the “manage user account” option. The property owner 203 may then modify 2203 personal particulars and details and confirm the modification 2206 or change 2204 password and confirm the change 2207. The property owner 203 may exit 2205 the user account management option. The user account is successfully updated 2208. The property owner 203 may exit 2209 to the main page. The property owner 203 may then exit 2210 the user account or proceed 2211 to other sections of the real estate website. The property owner 203 proceeds 2212 to the main page.

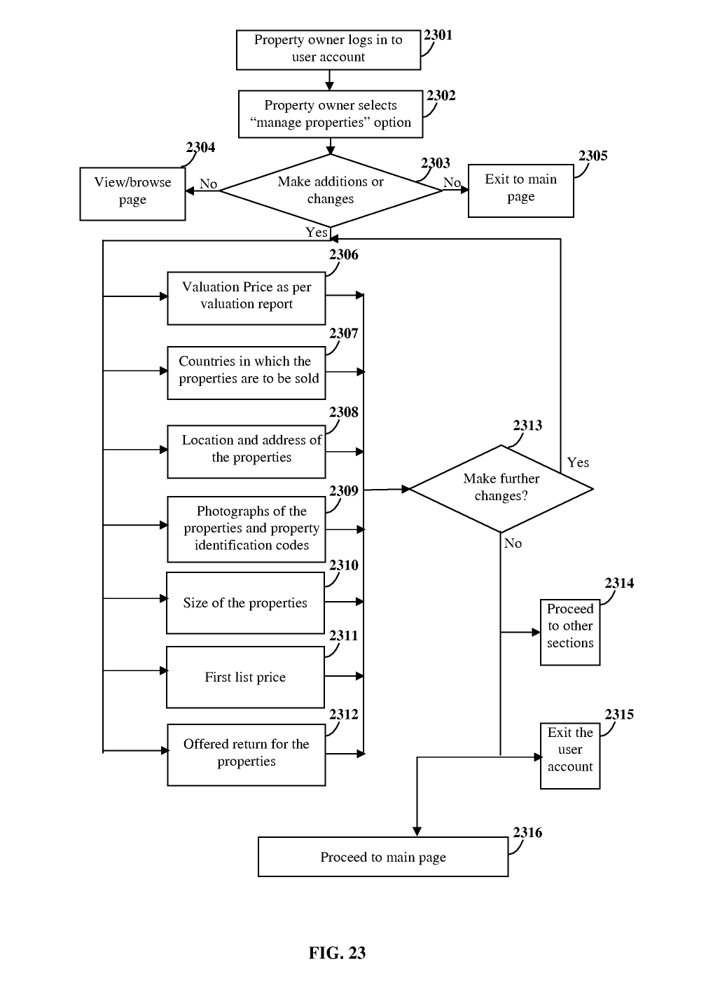

FIG. 23 exemplarily illustrates the steps involved in the property owner 203 managing the properties of the property owner 203 on the real estate website. The property owner 203 logs in 2301 to the property owner's 203 user account and selects 2302 the “manage properties” option. If the property owner 203 does not make any additions or changes 2303 to the properties, the property owner 203 may view or browse 2304 through the webpage. The property owner 203 may alternatively exit 2305 to the main page. The property owner 203 may add or modify valuation price as per valuation report 2306, countries in which the properties are to be sold 2307, location and address of the properties 2308, photographs of the properties and property identification codes 2309, size of the properties 2310, first list price set 2311, and offered return for the properties 2312. If the property owner 203 does not make further changes 2313, the property owner 203 may proceed 2314 to other sections of the real estate website or exit 2315 the user account. The property owner 203 may also proceed 2316 to the main page.

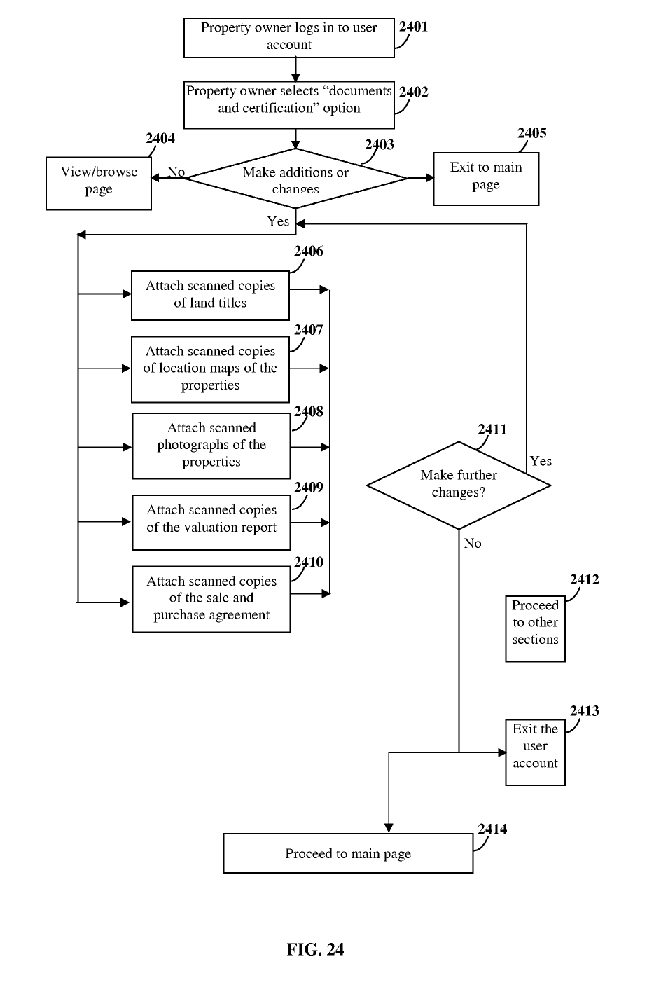

FIG. 24 exemplarily illustrates the steps involved in the property owner 203 managing the documents and certifications on the real estate website. The property owner 203 logs in 2401 to the property owner's 203 user account and selects 2402 the “manage documents and certification” option. If the property owner 203 does not make any additions or changes 2403 to the properties, the property owner 203 may view or browse 2404 through the webpage. The property owner 203 may alternatively exit 2405 to the main page. The property owner 203 may attach 2406 scanned copies of land titles, attach 2407 scanned copies of location maps of the properties, attach 2408 scanned photographs of the properties, attach 2409 scanned copies of the valuation report, and attach 2410 scanned copies of the sale and purchase agreement. If the property owner 203 does not make further changes 2411, the property owner 203 may proceed 2412 to other sections of the real estate website or exit 2413 the user account. The property owner 203 may also proceed 2414 to the main page.

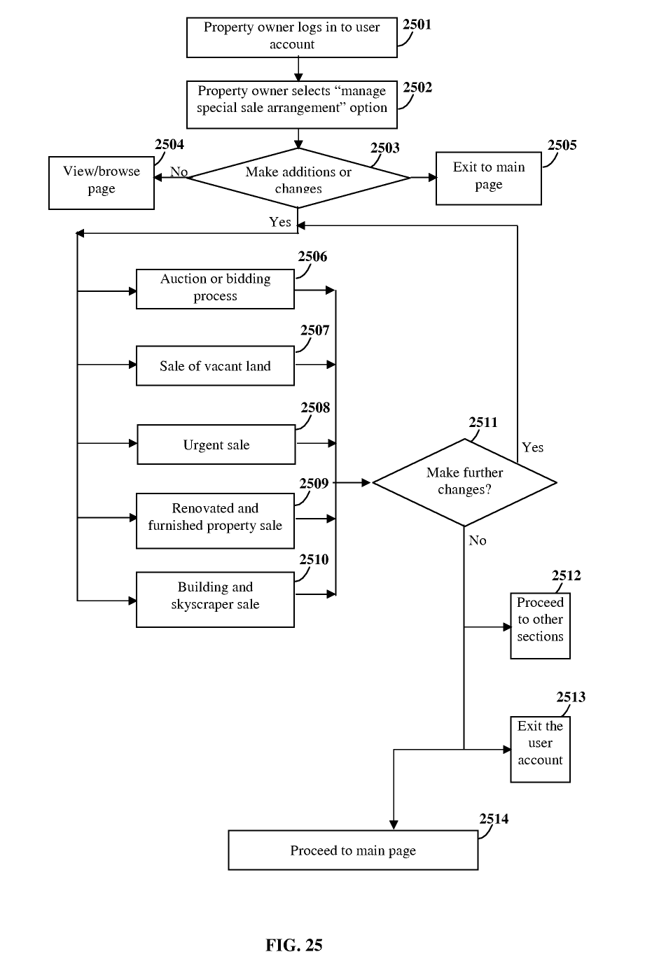

FIG. 25 exemplarily illustrates the steps involved in the property owner 203 managing special sale arrangements on the real estate website. The property owner 203 logs in 2501 to the property owner's 203 user account and selects 2502 the “manage special sale arrangements” option. If the property owner 203 does not make any additions or changes 2503 to the properties, the property owner 203 may view or browse 2504 through the webpage. The property owner 203 may alternatively exit 2505 to the main page. The property owner 203 may select the special sale arrangements, for example, auction or bidding process 2506, sale of vacant land 2507, urgent sale 2508, renovated and furnished property sale 2509, and building and skyscraper sale 2510. If the property owner 203 does not make further changes 2511, the property owner 203 may proceed 2512 to other sections of the real estate website or exit 2513 the user account. The property owner 203 may also proceed 2514 to the main page.

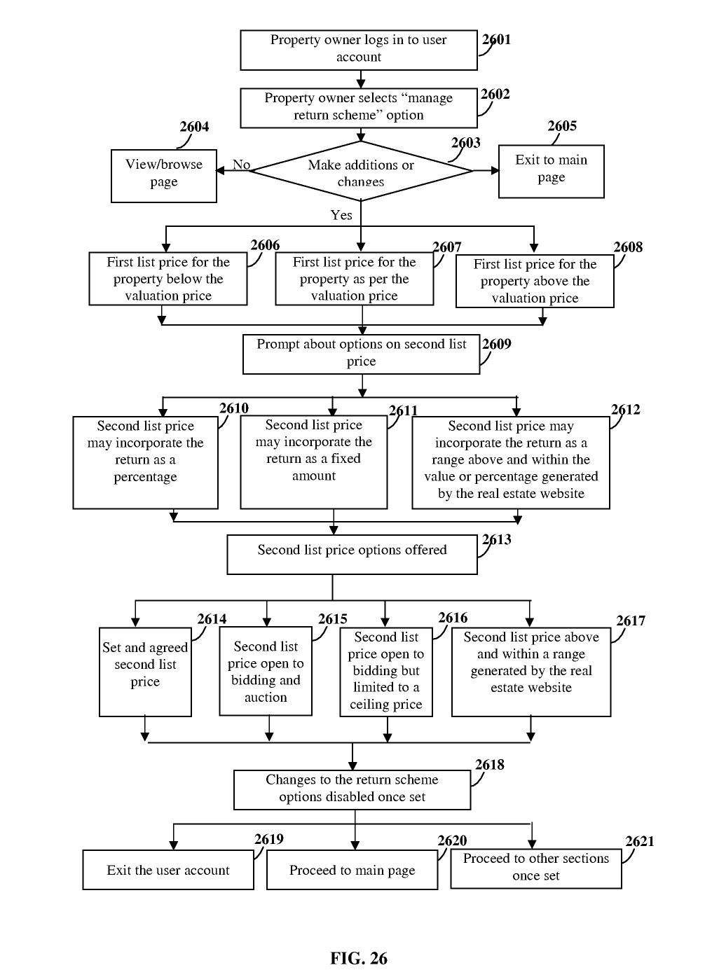

FIG. 26 exemplarily illustrates the steps involved in the property owner 203 managing the return scheme for regulating the sale on the real estate website. The property owner 203 logs in 2601 to the property owner's 203 user account and selects 2602 the “manage return scheme,” option. If the property owner 203 does not select any options 2603 for managing the return scheme, the property owner 203 may view or browse 2604 through the webpage. The property owner 203 may alternatively exit 2605 to the main page. The property owner 203 may set a first listing price for the property below 2606 the valuation price, as per 2607 the valuation price, or above 2608 the valuation price. The real estate website prompts 2609 the property owner 203 about options on the second list price. The second list price may incorporate 2610 the return as a percentage, incorporate 2611 the return as a fixed amount, or incorporate 2612 the return as a range above and within the value or percentage generated by the real estate website.

The real estate website may provide 2613 different options for the second list price to the property owner 203. The second list price may be set and agreed 2614 upon. The second list price may also be open to bidding and auction 2615. The second list price may be open to bidding but limited 2616 to a ceiling price generated by the real estate website. Further, the property owner 203 may select the second list price above and within a range 2617 generated by the real estate website. Once the options for the return scheme are set, the real estate website disables 2618 changes to be made to the return scheme options. The property owner 203 may then exit 2619 the user account, proceed 2620 to the main page, or proceed 2621 to other sections of the real estate website.

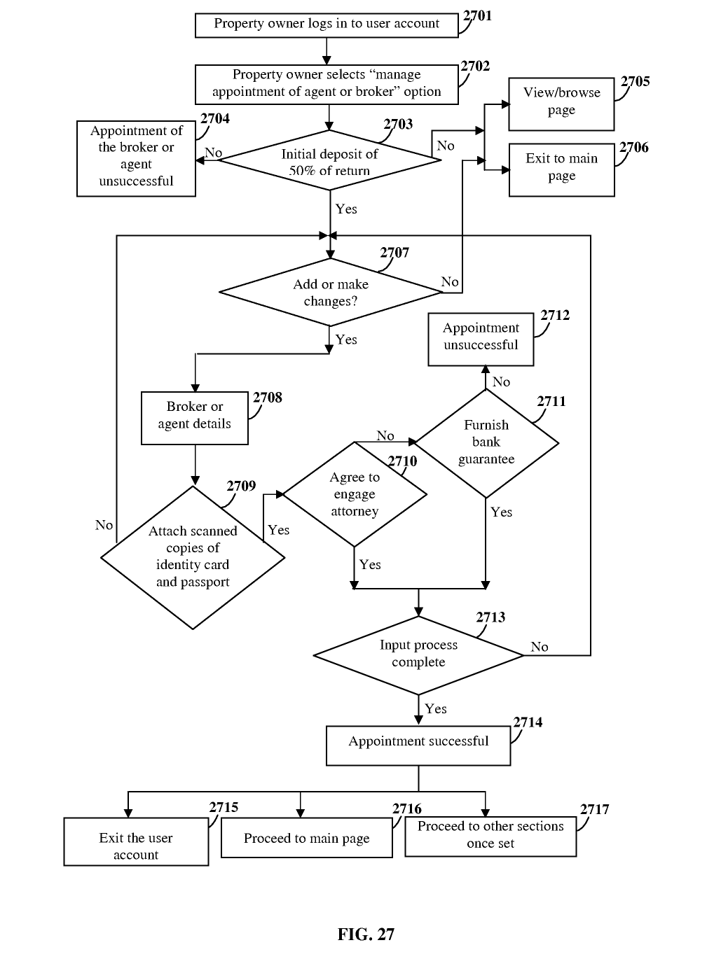

FIG. 27 exemplarily illustrates the steps involved in the property owner 203 managing the appointment of the agent or broker on the real estate website. The property owner 203 logs in 2701 to the property owner's 203 user account and selects 2702 the “manage appointment of agent or broker” option. If the property owner 203 fails to provide 2703 an initial deposit of 50% of the return, the appointment of the broker or agent is unsuccessful 2704. The property owner 203 may then view or browse 2705 the web page or exit 2706 to the main page. The property owner 203 may add or make changes 2707 to appointment preferences on making an initial deposit of 50% of the return. The property owner 203 may view 2708 broker or agent details. The property owner 203 may attach 2709 a scanned copy of identity card and passport. The property owner 203 may agree 2710 to engage an attorney. If the property owner 203 does not agree to engage an attorney, the bank guarantee may need to be furnished 2711. If the bank guarantee is not furnished, the appointment may be unsuccessful 2712. If the bank guarantee is furnished, the appointment process is completed 2713 and the appointment is successful 2714. The property owner 203 may then exit 2715 from the user account, proceed 2716 to the main page, or proceed 2717 to other sections of the real estate website.

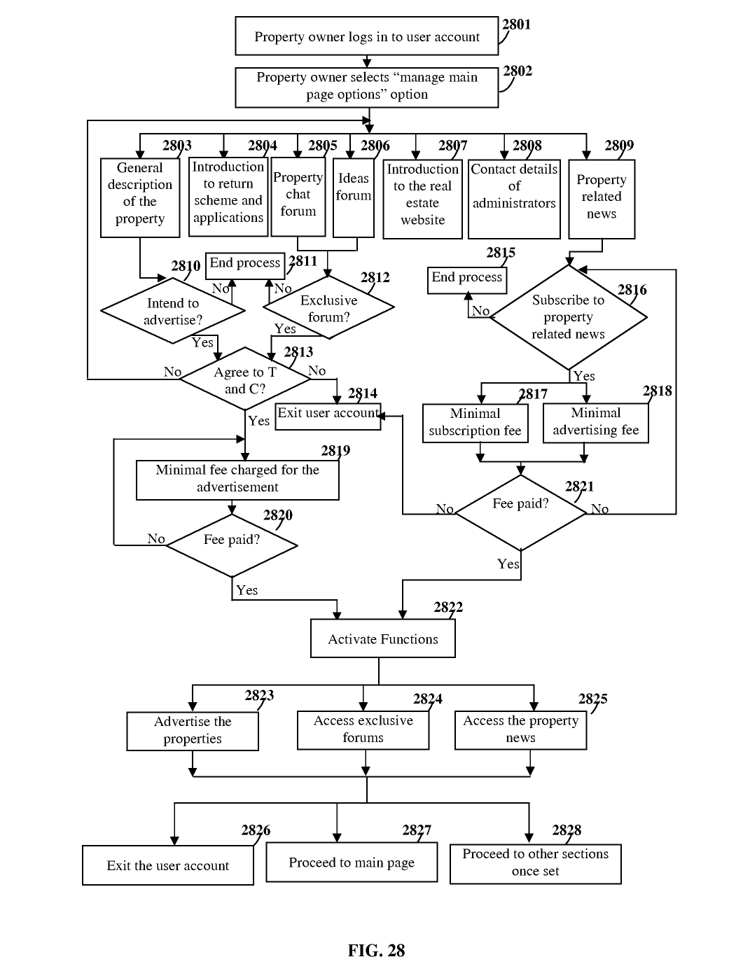

FIG. 28 exemplarily illustrates the steps involved in the property owner 203 managing the main page options on the real estate website. The property owner 203 logs in 2801 to the property owner's 203 user account and selects 2802 the “manage main page options” option. The property owner 203 may access, add, or modify the general description of the property 2803, introduction to the return scheme and applications 2804, the property chat forum 2805, an ideas forum 2806, an introduction to the real estate website 2807, contact details of administrators and other managers of the real estate website 2808, and property related news 2809. If the property owner 203 does not intend 2810 to advertise in the general description of the property, the property owner 203 may end 2811 the process. If the property owner 203 intends to advertise, the property owner 203 must agree 2813 to terms and conditions (T and C). If the property owner 203 does not agree to the terms and conditions, the property owner 203 may exit 2814 the user account. If the property owner 203 agrees to the terms and conditions, a minimal fee may be charged 2819 for the advertisement. If the property owner 203 pays 2820 the fee, advertising functions are activated 2822.

When the property owner 203 tries to access the property chat forum and the ideas forum, and the property chat forum and the ideas forum are exclusive forums 2812, the user may need to agree to terms and conditions of use of the real estate website. A minimal fee may be charged for accessing the exclusive forums. If the property owner 203 accesses the property related news 2809, the property owner 203 has an option to subscribe 2816 to the property related news. If the property owner 203 does not subscribe, the process ends 2815. A minimal subscription fee 2817 or a minimal advertising fee 2818 may be charged. If the property owner 203 pays the minimal fees 2821, news functions are activated 2822. The property owner 203 may then advertise 2823 the properties, access 2824 the exclusive forums, and access 2825 the property news. The property owner 203 may then exit 2826 the user account, proceed 2827 to the main page, or proceed 2828 to other sections of the real estate website.

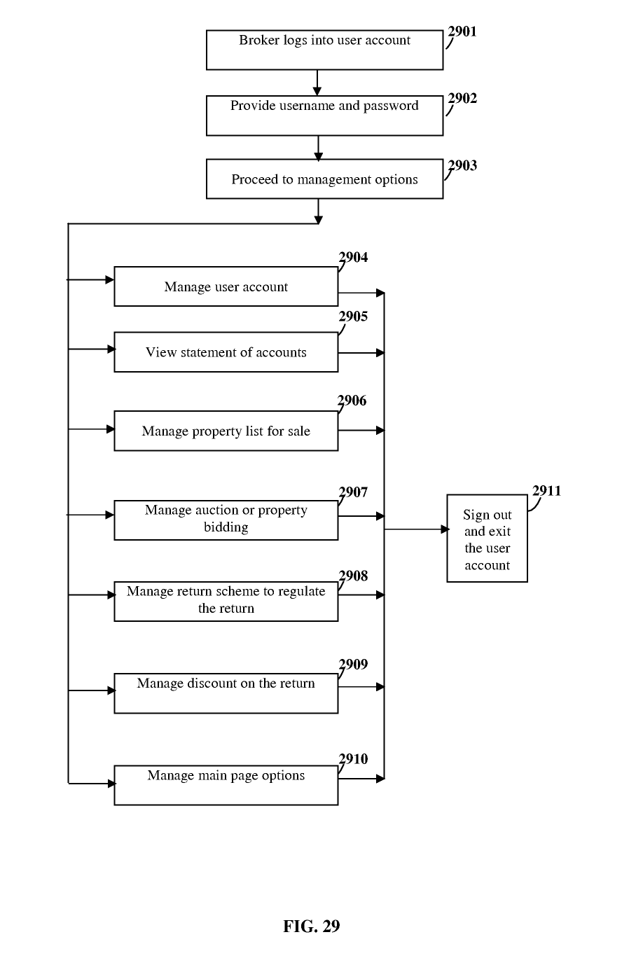

FIG. 29 exemplarily illustrates the steps involved in the broker accessing management options provided by the real estate website. The broker logs in 2901 to the broker's user account by providing 2902 a username and password. The property owner 203 then proceeds 2903 to multiple management options provided by the real estate website. The property owner 203 may manage 2904 the user account, view statement of accounts 2905, manage property list for sale 2906, manage auction or property bidding 2907, manage return scheme to regulate the return 2908, manage discount on the return 2909, and manage main page options 2910. The user may sign out of and exit 2911 the user account.

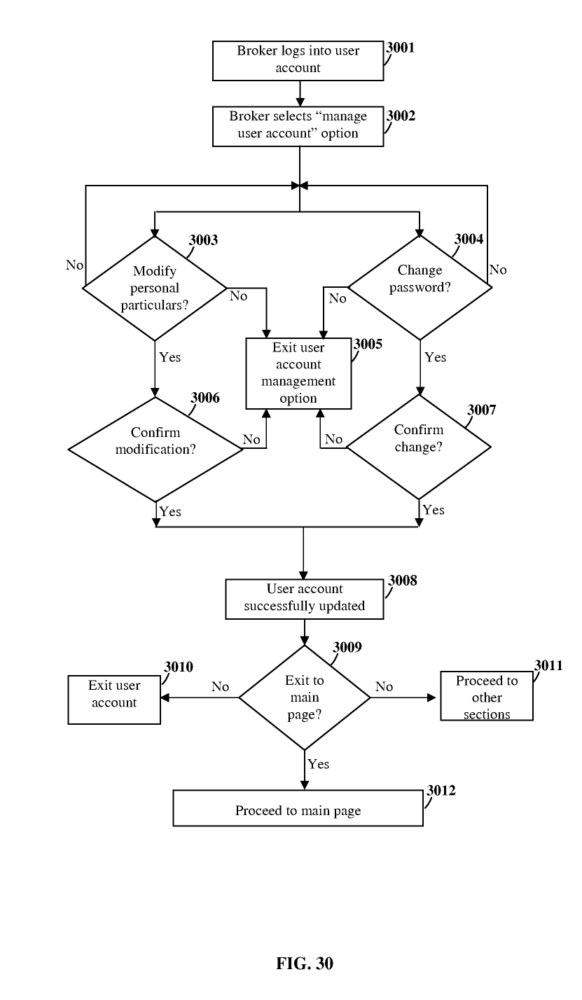

FIG. 30 exemplarily illustrates the steps involved in the broker managing the broker's user account on the real estate website. The broker logs in 3001 to the user account and selects 3002 the “manage user account” option. The broker may then modify 3003 personal particulars and details and confirm the modification 3006 or change 3004 password and confirm the change 3007. The broker may exit 3005 the user account management option. The user account is successfully updated 3008. The broker may exit 3009 to the main page. The broker may also exit 3010 the user account or proceed 3011 to other sections of the real estate website. The broker proceeds 3012 to the main page.

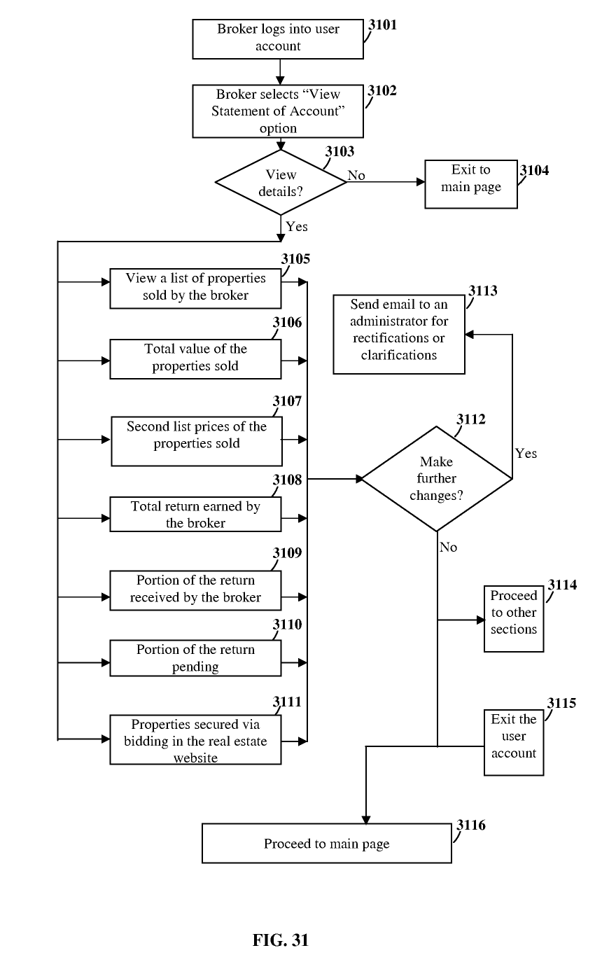

FIG. 31 exemplarily illustrates the steps involved in the broker viewing a statement of accounts on the real estate website. The broker logs in 3101 to the broker's user account and selects 3102 the “view statement of accounts” option. If the broker does not view details 3103 of the statements, the broker may exit to the main page 3104. The broker may view a list of properties sold by the broker 3105, total value of the properties sold 3106, second list prices of the properties sold by the broker 3107, total return earned by the broker 3108, portion of the return received by the broker 3109, portion of the return pending 3110, and properties secured via bidding on the real estate website 3111. If the broker needs to make changes 3112, the broker may send 3113 an electronic mail (email) to an administrator of the real estate website for rectifications or clarifications. If the broker does not need to make changes 3112, the broker may proceed 3114 to other sections of the real estate website or exit 3115 the user account. The broker may also proceed 3116 to the main page.

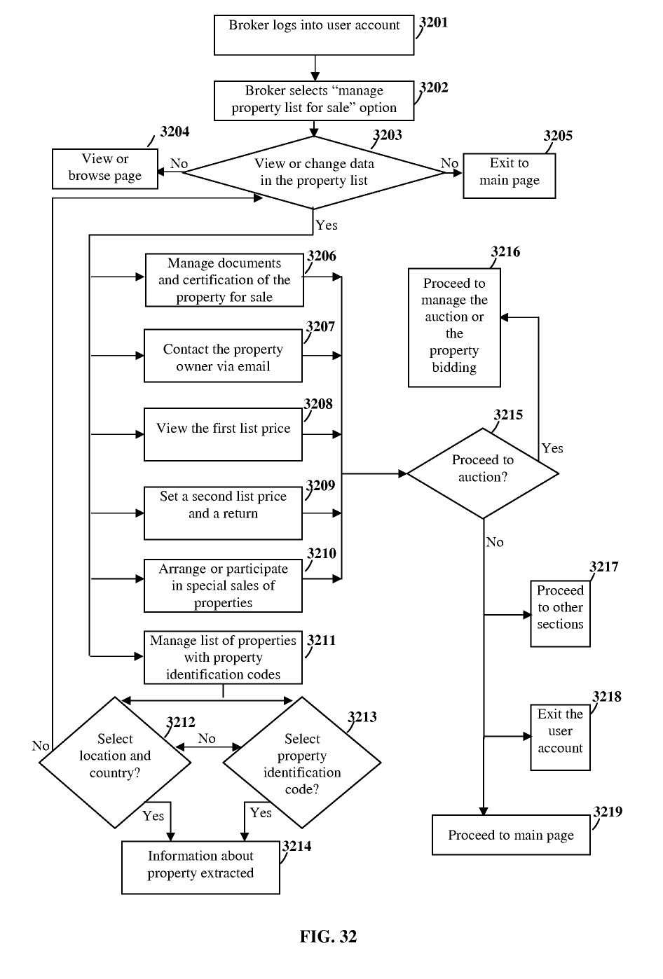

FIG. 32 exemplarily illustrates the steps involved in the broker managing a property list for sale on the real estate website. The broker logs in 3201 to the broker's user account and selects 3202 the “manage property list for sale” option. If the broker does not change 3203 any data in the property list, the broker may view or browse 3204 through the webpage. The broker may also exit 3205 to the main page. The broker may manage documents and certification of the property for sale 3206, contact the property owner 203 via email 3207, view the first list price 3208, set a second list price and a return 3209, arrange or participate in special sales of properties 3210, and manage list of properties with property identification codes 3211. The broker may select location and country 3212. If the broker does not select any option for managing the list of properties, the broker may either select the property identification code 3213 or revert to view or change data 3203 in the property list. Information about the property is then extracted 3214. If the broker wishes 3215 to proceed to an auction of the property, the broker may then proceed to manage 3216 the auction or the property bidding. If the broker does not wish to proceed to the auction, the broker may proceed 3217 to other sections of the real estate website or exit 3218 the user account. The broker may also proceed 3219 to the main page.

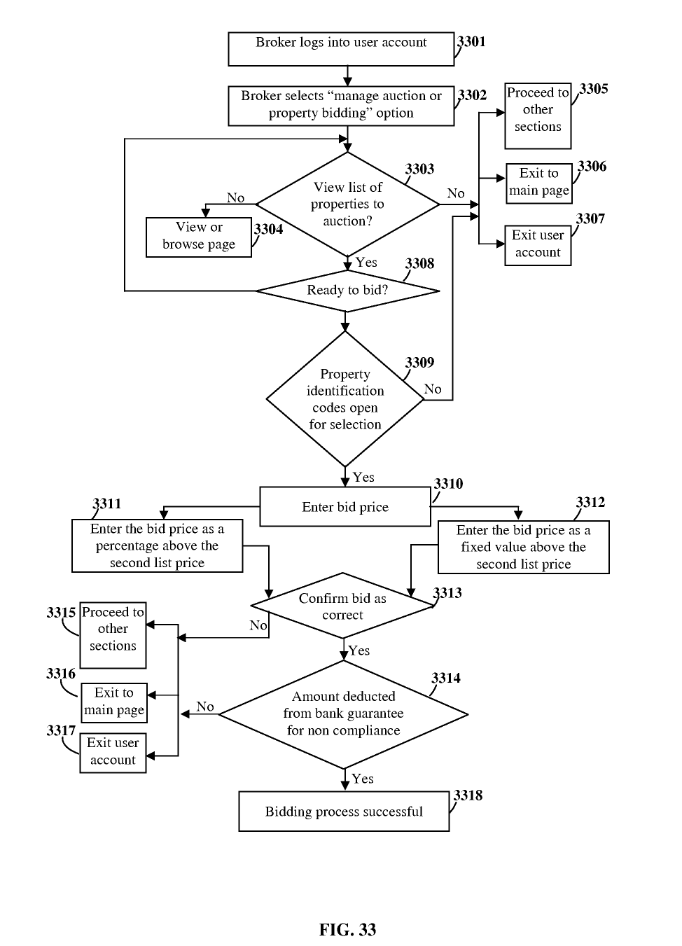

FIG. 33 exemplarily illustrates the steps involved in the broker managing an auction of the property on the real estate website. The broker logs in 3301 to the broker's user account and selects 3302 the “manage auction or property bidding” option. The broker may view 3303 a list of properties to auction. If the broker does not view the list of properties, the broker may view and browse 3304 the webpage. The broker may also proceed 3305 to other sections of the real estate website, exit 3307 the user account, or proceed 3306 to the main page. If the auction is ready for bidding 3308 and the property identification codes are open 3309 for selection, the broker enters the bid price 3310. The broker may enter the bid price as a percentage above the second list price 3311 or a set value above the second list price 3312. If the bid price is not confirmed 3313 as correct, the broker may proceed 3315 to other sections of the real estate website, exit 3317 the user account, or exit 3316 to the main page. In case the broker has not complied with the terms and conditions or the sale and purchase agreement an amount is deducted 3314 from the bank guarantee. The bidding process is successfully completed 3318.

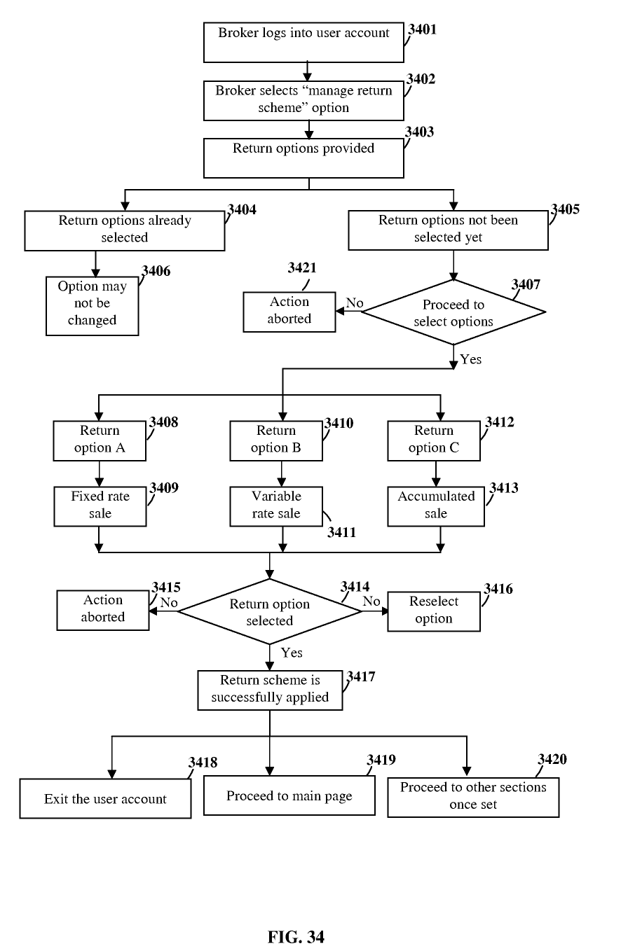

FIG. 34 exemplarily illustrates the steps involved in the broker managing the return scheme on the real estate website. The broker logs in 3401 to the broker's user account and selects 3402 the “manage return scheme” option. The real estate website provides return options 3403 for the broker to select. For properties for which the return option has already been selected 3404, the return option may not be changed 3406. For properties for which the return option has not been selected 3405, the broker may proceed to select 3407 the return options or abort the action 3421. The return options may, for example, be return option A 3408, return option B 3410, and return option C 3412. Return option A 3408 may be a fixed rate sale 3409, wherein a flat return rate, for example, 35%, is fixed. Return option B 3410 may be a variable rate sale 3411, wherein the return rate varies with the sale price. Return option C 3412 may be an accumulated sale 3413, wherein the return rate is based on multiple sales and sale prices of each of the sales. The return rate for each of the sales may be different. The broker selects 3414 the return option. If unsuccessful, the action may be aborted 3415 or the broker may reselect 3416 the return option. The return scheme is successfully applied 3417. The broker may proceed 3420 to other sections of the real estate website, exit 3418 the user account, or proceed 3419 to the main page.

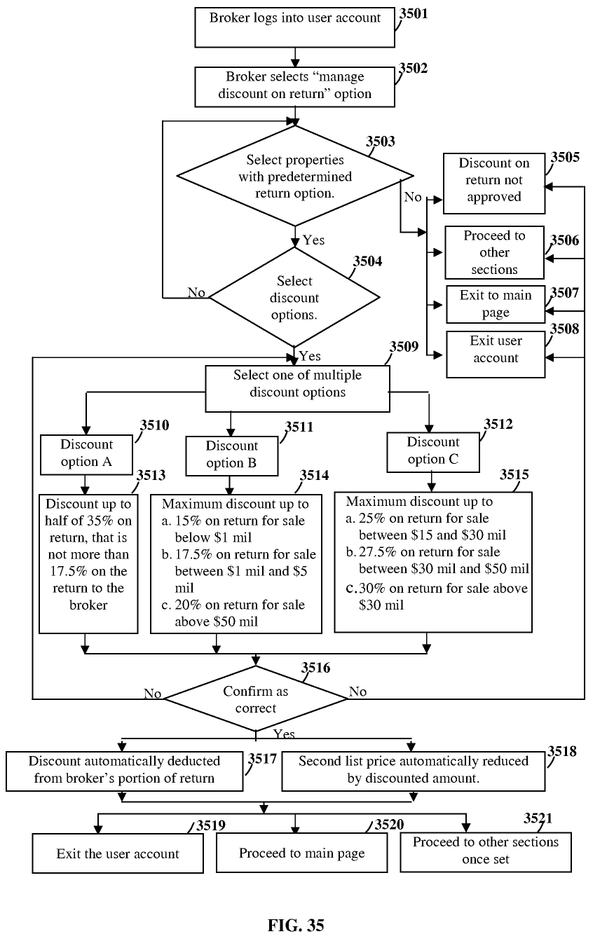

FIG. 35 exemplarily illustrates the steps involved in the broker managing the discounts on the properties given to the buyer 205 on the real estate website. The broker logs in 3501 to the broker's user account and selects 3502 the “manage discounts” option. The broker selects 3503 properties with predetermined return option. The broker selects 3504 discount options. The discount on return may not be approved 3505. The broker may proceed 3506 to other sections of the real estate website or exit 3507 the user account. The broker may also proceed 3508 to the main page. For properties with the return option, the broker selects 3509 one of multiple discount options offered by the real estate website. The discount options may, for example, be discount option A 3510, discount option B 3511, or discount option C 3512. In discount option A, the discount given may be 3513 up to half the remitted return. Total discount given to the buyer 205 does not exceed 17.5% of the return. In discount option B, the discount may depend 3514 on the sale price. In discount option C also, the discount may depend 3515 on the price. Discount option C may be used for high priced properties. The broker confirms 3516 the discount as correct. The discount may automatically be deducted 3517 from the broker's portion of the return. The second list price may be automatically reduced 3518 by the discounted amount. The broker may proceed 3521 to other sections of the real estate website, exit 3519 the user account, or proceed 3520 to the main page.

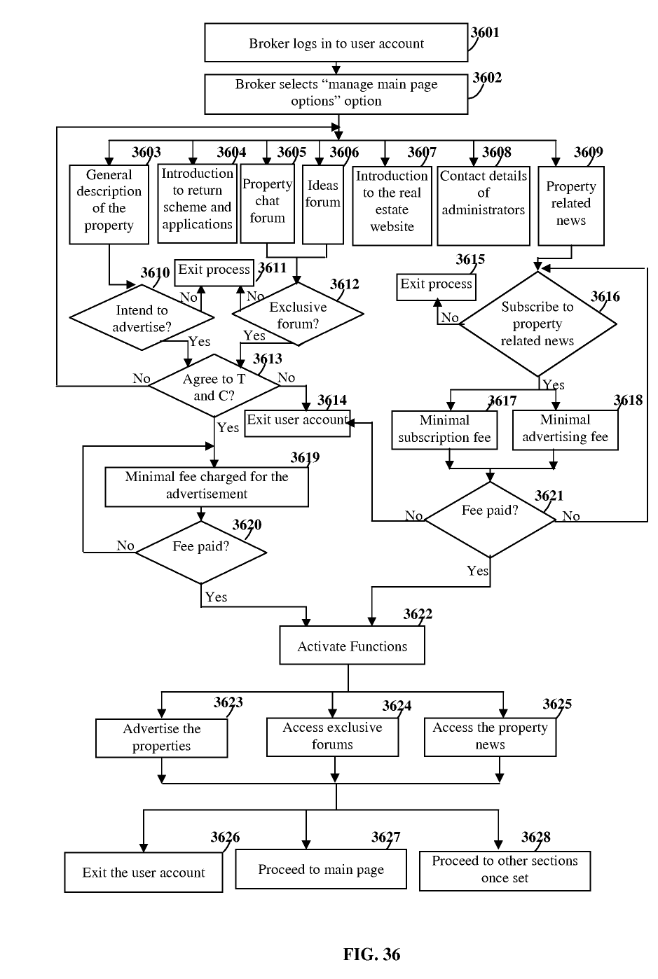

FIG. 36 exemplarily illustrates the steps involved in the broker managing the main page options on the real estate website. The broker logs in 3601 to the broker's user account and selects 3602 the “manage main page options” option. The broker may access, add, or modify general description of the property 3603, introduction to the return scheme and applications 3604, the property chat forum 3605, an ideas forum 3606, an introduction to the real estate website 3607, contact details of administrators and other managers of the real estate website 3608, and property related news 3609. If the broker does not intend 3610 to advertise in the general description of the property, the broker may end 3611 the process. If the broker intends to advertise, the broker must agree 3613 to terms and conditions. If the broker does not agree to the terms and conditions, the broker may exit 3614 the user account. If the broker agrees to the terms and conditions, a minimal fee may be charged 3619 for the advertisement. If the broker pays 3620 the fee, advertising functions are activated 3622.

When the broker tries to access the property chat forum and the ideas forum, if the property chat forum and the ideas forum are exclusive forums 3612, the broker may need to agree to terms and conditions of use of the real estate website. A minimal fee may be charged for accessing the exclusive forums. If the broker accesses the property related news 3609, the broker has an option to subscribe 3616 to the property related news. If the broker does not subscribe to the property related news, the process exits 3615. A minimal subscription fee 3617 or a minimal advertising fee 3618 may be charged. If the broker pays the minimal fees 3621, news functions are activated 3622. The broker may then advertise 3623 the properties wanted, access 3624 the exclusive forums, and access 3625 the property news. The broker may then exit 3626 the user account, proceed 3627 to the main page, or proceed 3628 to other sections of the real estate website.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in different manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

Where databases are described such as the real estate database 201f, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The foregoing examples have been provided merely for the purpose of explanation and are in no way to be construed as limiting of the present invention. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of negating payment of a commission to one or more real estate professionals by a property owner on sale of a property of said property owner over an electronic environment, comprising the steps of:
setting a first list price for said property by the property owner, wherein a real estate professional agrees to said set first list price;
setting a second list price greater than said agreed first list price by said real estate professional;
entering into a sales agreement by the property owner and the real estate professional, wherein said sales agreement is an agreement to list the property of the property owner to a buyer at said second list price over said electronic environment;
negotiating a sale of the property at the second list price between said buyer and the property owner by the real estate professional;
selling the property at the second list price based on said negotiation; and
remitting a return of the difference between the second list price and the first list price to the real estate professional over the electronic environment, wherein said remittance of said return negates payment of said commission by the property owner;
whereby no commission is paid by the property owner to the real estate professional on said sale of the property of the property owner.

2. The computer implemented method of claim 1, wherein said step of setting of the first list price comprises the step of valuating the property for generating a valuation price in the electronic environment, wherein the first list price is determined based on said generated valuation price.

3. The computer implemented method of claim 1, wherein said step of entering into the sales agreement comprises the steps of:
entering into an agreement by a main agent and one or more secondary agents from one or more of said real estate professionals appointed by the property owner to represent the property owner; and
determining fractions of the return distributed between said main agent and said secondary agents.

4. The computer implemented method of claim 1, further comprising the step of setting multiple second list prices by the real estate professional, wherein fractions of the return are distributed among one or more of the real estate professionals based on said second list prices.

5. The computer implemented method of claim 1, further comprising the step of offering a concession to the buyer by the real estate professional, wherein said concession is forfeited from the return to the real estate professional.

6. The computer implemented method of claim 1, wherein the property is sold at a sale price above the second list price, wherein difference between said sale price and the second list price is remitted to the real estate professional.

7. The computer implemented method of claim 1, wherein the property is sold by the property owner at a sale price below the second list price, wherein difference between the second list price and said sale price is remitted to the real estate professional by the property owner.

8. The computer implemented method of claim 1, wherein fractions of the return distributed among one or more of the real estate professionals are determined based on an agreement entered into between the real estate professionals.

9. The computer implemented method of claim 1, wherein fractions of the return are determined based on difference between any two of the first list price, the second list price, and the sale price, wherein said sale price is a price at which the property is sold to the buyer.

10. A computer implemented system for negating payment of a commission to one or more real estate professionals by a property owner on sale of a property of said property owner over an electronic environment, comprising:
a first pricing module for enabling the property owner to set a first list price for said property, wherein a real estate professional agrees to said first list price;
a second pricing module for enabling said real estate professional to set a second list price greater than said agreed first list price;
a graphical user interface for enabling:
the property owner and one or more of said real estate professionals to enter into a sales agreement, wherein said sales agreement is an agreement to sell the property of the property owner to a buyer at said second list price over said electronic environment;
the real estate professional to negotiate a sale of the property at the second list price between said buyer and the property owner;
a sales module for enabling said sale of the property at the second list price based on said negotiation; and
a return remittance module for remitting a return of difference between the second list price and the first list price to the real estate professional over the electronic environment, wherein said remittance of said return negates payment of said commission by the property owner.

11. The computer implemented system of claim 10, wherein said first pricing module, said second pricing module, said sales module, and said return remittance module are on a real estate server in the electronic environment.

12. The computer implemented system of claim 10, further comprising a valuation module for valuating the property for generating a valuation price in the electronic environment, wherein the first pricing module determines the first list price of the property based on said generated valuation price.

13. The computer implemented system of claim 10, wherein said graphical user interface further enables:
a main agent and one or more secondary agents from one or more of said real estate professionals appointed by the property owner to enter into an agreement to represent the property owner; and
determination of fractions of the return distributed between said main agent and said secondary agents.

14. The computer implemented system of claim 13, wherein the return remittance module determines said fractions of the return distributed between the main agent and the secondary agents.

15. The computer implemented system of claim 10, wherein said second pricing module enables the real estate professional to set multiple second list prices, wherein fractions of the return distributed among one or more of the real estate professionals are determined based on said set second list prices.

16. The computer implemented system of claim 10, wherein said graphical user interface further enables the real estate professional to offer a concession to the buyer, wherein said concession is forfeited from the return to the real estate professional.

17. The computer implemented system of claim 10, wherein said sales module enables the sale of the property at a sale price above the second list price, wherein difference between said sale price and the second list price is remitted to the real estate professional.

18. The computer implemented system of claim 10, said sales module enables the property owner to sell the property at a sale price below the second list price, wherein difference between the second list price and said sale price is remitted to the real estate professional by the property owner.

19. The computer implemented system of claim 10, further comprising a real estate database for storing a list of the real estate professionals, fractions of the return distributed, and a history of sales.

20. A computer program product comprising computer executable instructions embodied in a computer-readable medium, wherein said computer program product comprises:
a first computer parsable program code for enabling a property owner to set a first list price for a property of said property owner, wherein the real estate professional agrees to said set first list price;
a second computer parsable program code for enabling the real estate professional to set a second list price greater than said agreed first list price;
a third computer parsable program code for enabling the property owner and the real estate professional to enter into a sales agreement, wherein said sales agreement is an agreement to list the property of the property owner to a buyer at said set second list price over an electronic environment;
a fourth computer parsable program code for enabling the real estate professional to negotiate a sale of the property at the second list price between said buyer and the property owner;
a fifth computer parsable program code for enabling said sale of the property at the second sale price based on said negotiation; and
a sixth computer parsable program code for remitting a return of difference between the second list price and the first list price to the real estate professional over said electronic environment, wherein said remittance of said return negates payment of commission by the property owner.
